(19) United States
(12) Patent Application Publication
(10) Pub. No.: US 2002/0154646 A1
(43) Pub. Date: Oct. 24, 2002

(54) Programmable network services node

(76) Inventors: Jean F. Dubois, Harvard, MA (US); Ronald E. Staub, Shrewsbury, MA (US)

Correspondence Address: HALE AND DORR, LLP, 60 STATE STREET, BOSTON, MA, 02109

(21) Appl. No.: 10/104,080

(22) Filed: Mar. 21, 2002

Related U.S. Application Data
(60) Provisional application No. 60/277,689, filed on Mar. 21, 2001.

(51) Int. Cl. H04L 12/28; H04L 12/50

(52) U.S. Cl. 370/406; 370/378

(57) ABSTRACT

A programmable network services node system for providing call services to subscribers, the system having a control processing module, a communications resource module having a network interface which may be connected to an external network, a digital signal processing resource module having a circuit network which may be connected to an external circuit switch network, a switching resource module and an access processing module. The control processing module can provide platform processing control of the system and can also process received services programming instructions and the communications resource module can perform call processing. The switching resource module can provide switching controls within the system and the access processing module can provide access processing control within the system. The system may also have a meshed network which is populated by the communications resource module(s) and the digital signal processing resource module(s).

### REFERENCE TO RELATED U.S. APPLICATIONS

This application claims priority to U.S. Provisional Patent Application No. 60/277,689 filed Mar. 21, 2001, the entire contents of which are herein incorporated by reference.

### BACKGROUND

The present disclosure relates generally to programmable network services node systems and, more particularly, programmable network services node systems which can interface with existing packet-based, cell-based and/or circuit switched networks.

Using current technology, service providers typically are forced to compromise between the shortcomings of inflexible legacy infrastructure equipment and the limitations of first generation broadband products. Often such legacy infrastructure equipment is not able to facilitate new or enhanced services as they may come available. These prior broadband products for converged voice and data services tend to have complex, multi-product architectures that are hard to deploy, operate, and manage. Such architectures do not meet the needs of local service providers. The equipment lacks the rapid service creation capability that can provide competitive advantage for service providers competing on service differentiation and time to market.

### SUMMARY OF THE DISCLOSURE

The present disclosure relates to programmable services node systems, sometimes referred to herein as PSN or PSN system. In accordance with one aspect of the PSN disclosed herein, the PSN may be operated as a programmable broadband service switch that, in one aspect, integrates a media gateway, edge switch router, media gateway controller, signaling gateway, call agent and an enhanced application server at a local service point of presence.

In accordance with one aspect of the PSN disclosed herein, the PSN can provide connectivity to voice and data networks (e.g., ATM, IP, Frame Relay and TDM networks) and a framework for managing those connections. Additionally, in certain exemplary embodiments, the PSN may provide an environment for service creation. At its highest level, the embodiments of the PSN described herein may be composed of two major functional subassemblies: 1) a Platform Control Subsystem (PCS) which may provide call management processes and service creation applications, and 2) an Access Control Subsystem (ACS) which may provide physical connectivity, data and voice processing resources, and base level protocol stacks. In certain preferred embodiment, the PSN may utilize a signaling system 7 (SS7) interface for interfacing with a SS7 signaling link.

In an exemplary embodiment in accordance with the present disclosure, a programmable network services node system for providing call services to subscribers may include a control processing module which provides platform processing control of the system and which can process received services programming instructions, a communications resource module which performs call processing and which has a network interface which interfaces with a packet-based network and/or a cell-based network, a digital signal processing resource module which performs call protocol conversions and which a circuit interface which interfaces with a circuit-based network, a switching resource module for providing switching controls within the system and an access processing module for providing access processing control within the system and which is coupled to the switching resource module.

In another exemplary embodiment, the programmable network services node system may further include a meshed network which is populated by the communications resource module(s) and the one digital signal processing resource module(s). Additionally, in other exemplary embodiments, the switching resource module(s) may also populate the meshed network.

In certain exemplary embodiments, the communications resource module has a network processor module, a control processor module and a mesh interface. The mesh interface can be connected to the meshed network. Similarly, in other certain exemplary embodiments, the digital signal processing resource module can include a control processor module, a digital signal processor module and a mesh interface which also can interface with the meshed network. The digital signal processor module may have an array of digital signal processors.

In yet another exemplary embodiment in accordance with the present disclosure, the programmable network services node system may further include a status module which, amongst other things, may provide a connection between the control processing module and the switching resource module. Some status modules may utilize an Ethernet switch.

In yet further exemplary embodiment in accordance with the present disclosure, certain programmable network services node system may include a signaling system 7 interface which is coupled to the control processing module.

In an exemplary embodiment, the programmable network services node system can further include a chassis having a plurality of CompactPCI-compliant card locations. In such a configuration, the control processing module could be a scalable processor architecture-based CompactPCI form factor single board computer, the switching resource module could be an IP switch board CompactPCI form factor single board computer, the access processing module could be a microprocessor CompactPCI form factor single board computer, and the communications resource module and digital signal processing resource module could be input/output CompactCPI cards.

In accordance with another aspect of the PSN systems disclosed herein, a PSN may be comprised of a platform control subsystem having an service application layer for facilitating call processing services, a call control layer for providing basic originating and terminating call models and an object-based execution environment for processing calls, and a call control interface for bridging the service application layer and the call control layer. Such a system may also include an access control subsystem for managing the identification and establishment of call endpoints and call channels within the system and a switch router layer for routing calls.

In an exemplary embodiment, the service application layer can include an application server for hosting a service logic execution environment which can for enhanced call processing services. The service logic execution environment can be an open environment isolated from the call control layer. In a preferred embodiment, the service logic execution environment is a JAIN-based execution environment which can support third-party service logic programs.

### BRIEF DESCRIPTION OF THE DRAWINGS

For a fuller understanding of the nature and objects of the present invention, reference should be made to the following detailed description taken in connection with the accompanying drawings wherein:

FIG. 1 illustrates one embodiment of a programmable network services node.

FIG. 2 illustrates another embodiment of a programmable network services node

FIG. 3 depicts front and rear views of one embodiment of a programmable network services node.

FIG. 4 depicts one embodiment for arranging the modules of a programmable network services node modules on a chassis.

FIG. 5 depicts one embodiment of a PSN modules configuration.

FIG. 6 depicts one embodiment of a communications resource module.

FIG. 7 depicts one embodiment of a digital signaling processing module.

FIG. 8 depicts one embodiment of a status module.

FIG. 9 illustrates one embodiment of a PSN system architecture.

FIG. 10 illustrates one embodiment of a service application layer.

FIG. 11 illustrates one embodiment of a call control layer.

FIG. 12 illustrates one embodiment of a call control infrastructure.

FIG. 13 illustrates one embodiment of a network and system management module.

FIG. 14 illustrates one embodiment of an access control subsystem.

FIG. 15 illustrates another embodiment of an access control subsystem.

FIG. 16 illustrates one embodiment of the communications resource module architecture.

FIG. 17 illustrates one embodiment of the digital signal processing resource module architecture.

Like reference numerals denote like parts in the drawings.

### DETAILED DESCRIPTION OF PREFERRED EMBODIMENTS

In accordance with the present disclosure, in certain embodiments the programmable services node (PSN) system can serve as a carrier class, multi-access, edge service switch that supports ATM, IP, Frame Relay and TDM traffic. The PSN systems described herein may provide an integrated softswitch and a service creation environment designed for broadband local service providers and targeted at the small-to-medium enterprise voice and data services market. Certain exemplary embodiments of the PSN systems described herein can integrate a leading-edge media gateway, media gateway controller, signaling gateway, call agent, enhanced application server, and edge switch router all in a single chassis. In accordance with the present disclosure, a PSN system 10 may support ATM, IP, and TDM-based traffic, amongst others. Because of the PSN system 10's ability to exchange voice and data traffic between ATM, TDM, and IP networks, for example, the PSN system 10 may act as network convergence node.

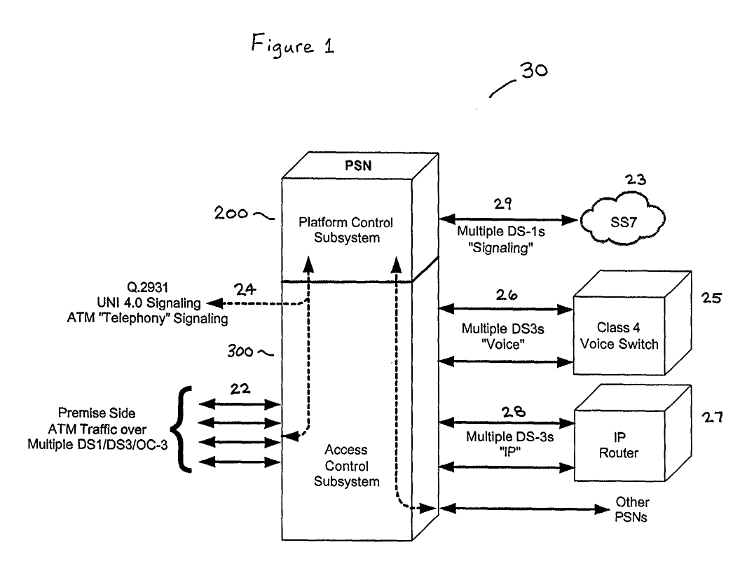

FIG. 1 illustrates, in accordance with the present disclosure, the two major subsystems of an exemplary programmable services node (PSN) 30: the Platform Control Subsystem (PCS) 200 and the Access Control Subsystem (ACS) 300. FIG. 1 also illustrates some of the typical traffic/signaling flows that the PSN 30 may be capable of processing. The PSN 30 of FIG. 1, for example, may be capable of receiving and routing ATM traffic 22 to/from an external ATM network, ATM signaling traffic 24, circuit switch voice traffic 26 (e.g., TDM) to/from a TDM based network (such as to/from a Class 4 voice switch 25 as depicted), and IP traffic 18 to/from as IP based network (such as to/from an IP router 27 as depicted). In the preferred embodiment depicted in FIG. 1, the PSN 30 may also be capable of receiving and routing circuit switch signaling traffic 29 (e.g., SS7 traffic) from an SS7 network 23.

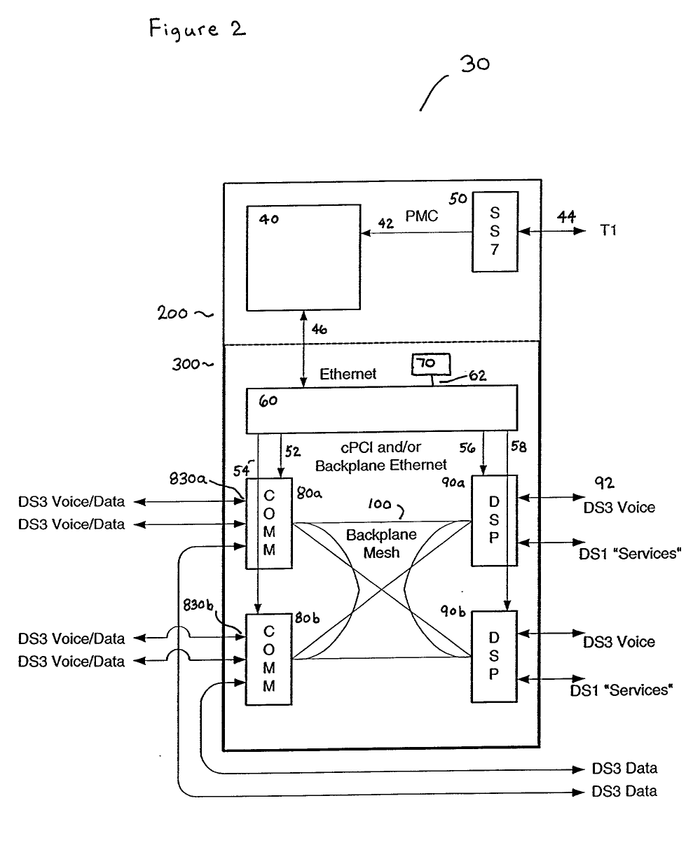

As discussed below, the ACS 300 of the present disclosure provides physical connectivity, data and voice processing resources, and base-level protocol stacks. The ACS 300 can exchange call setup information with the PCS 200 and perform the setup of these calls using the I/O resources of the communications resource modules 70 and digital signal processing resource modules 80 (of FIG. 2). The PCS 200 provides the call management functions and service logic execution environment (SLEE 215), as more fully described below. In accordance with the present disclosure, the PCS 200 can manage and monitor the PSN 30 resources that are used for connectivity with and between networks. This management of PSN 30 resource can include the selection of digital signal processing resource modules 80 resources used and the establishment of the traffic paths within the PSN system 30.

FIG. 2 illustrates the next level of detail found within a preferred embodiment of the PSN 30 architecture. At this level the individual hardware components are visible. In accordance with the present disclosure, an exemplary embodiment of a PSN 30 may include a control processing module 40 and a signaling system interface 50 located within the PCs 200, and a switching resource module 60, an access processing module 70, communications resource modules 80a, 80b, digital signal processing resource modules 90a, 90b and a meshed network 100 located within the ACS 300. The meshed network 100 meshes (i.e., connects) the communications resource modules 80a, 80b and digital signal processing resource modules 90a, 90b together (i.e., the communications resource modules 80a, 80b and digital signal processing resource modules 90a, 90b populate the meshed network 100). The SS7 interface can be capable of receiving and transmitting SS7 signaling information to/from an a SS7 signaling network (not shown) via link 44. Link 44 may be a T1 connection. As illustrated in FIG. 2, the control processing module 40 is coupled to the SS7 interface 50, via link 42, and to the switching resource module 60, via link 46. Similarly, the switching resource module 60 is coupled to the access processing module 70 via link 62. Additionally, the switching resource module 60 is coupled to the communications resource modules 80a, 80b and digital signal processing resource modules 90a, 90b via links 52, 54, 56 and 58, respectively. The communications resource modules 80a, 80b and digital signal processing resource modules 90a, 90b each populate a meshed network 100 which interconnects each communications resource module 80 to each digital signal processing resource module 90 and the other communications resource modules 80, and each digital signal processing resource module 90 to the other digital signal processing resource modules 90.

The communications resource modules (CRM) 80a, 80b each have a network interface 830a, 830b (respectively) which is capable of interfacing with a packet-based network (e.g., an IP network) and/or a cell-based network (e.g., an ATM network). The communications resource modules 80 provides a connection—amongst other functions—between the network interface 830 and the meshed network 100. The digital signal processing resource modules 90a, 90b each have a circuit interface 930a, 930b (respectively) which is capable of interfacing with a circuit-based network, such as a TDM based network for example. The digital signal processing resource modules 90a, 90b may be capable of converting both ATM and IP packets into (and from) a circuit switch TDM protoco/format.

In a preferred embodiment in accordance with the present disclosure, the PSN system 30 can include a CompactPCI chassis where the modules of the PSN 30 are cards which reside within the chassis. In such an embodiment, the control processing module 40 may be a scalable processor architecture-based CompactPCI form factor single board computer, the switching resource module 60 an IP switch board CompactPCI form factor single board computer, the access processing module 70 a microprocessor CompactPCI form factor single board computer, the communications resource module 80 an input/output CompactCPI card and the digital signal processing resource module an input/output CompactCPI card. However, other I/O cards and Single Board Computers (SBCs) can be used without departing from the scope of the present disclosure. Thus, the particular hardware and software components and communications links are identified herein to only describe a preferred embodiment and not to limit the scope of the disclosure.

In accordance with the present disclosure, voice/data traffic received from external networks flows between the communications resource modules 80a, 80b and digital signal processing resource modules 90a, 90b (e.g., the I/O cards) over the meshed network 100. In a preferred embodiment, the meshed network 100 has a full mesh of serial Gigabit links. The access processing module 70 can control (i.e., via the switching resource module 60 and/or status module 110) the communications resource modules 80a, 80b and digital signal processing resource modules 90a, 90b across a CompactPCI (cPCI) backplane, via either a cPCI bus and/or redundant 100 Backplane Ethernet links, for example. The control processing module 40 and the access processing module 70 can communicate via internal 100 MBit Ethernet links (directly or via the switching resource module 60). In a preferred embodiment, the signaling system interface 50 is a Signaling System 7 (SS7 ) interface that is capable of interfacing with a SS7 network to receive/transmit SS7 signaling controls necessary to support the circuit switch traffic. The signaling system interface 50 and the control processing module 40 may communicate to each other via the control processing module 40's onboard PCI bus. The physical links 92 on the digital signal processing resource modules 90a, 90b can either be DS3 Inter-Machine Trunks (IMT) for connection to Class 4/Class 5 type switches or DS1 Trunks for connection to Adjunct Services equipment, e.g. voice mail or 911 Services.

Not shown in FIGS. 1 or 2 are any of the components providing the redundancy useful for High Availability operating environments. Preferably, there is redundancy for each of the hardware components shown above.

The PSN system 30 can, in various aspects, include one or more of the following components and functionality: A native ATM and native IP/MPLS programmable switch fabric that can provide scalability and uniformity of network services across various packet access technologies used by service providers such as ATM over T1 and DSL, fixed wireless (such as UNII, LMDS, MMDS), mobile wireless, and cable; a distributed switch fabric architecture; an all-in-one chassis and open programmable broadband service switch that can simplify the service delivery infrastructure in packet networks and supports layered Application Program Interfaces (API) for programmability of call control, signaling, and media layer functions; a converged Service Creation Environment (SCE) coupled with a service delivery switch that enable the rapid creation, prototyping, and deployment of enhanced services over broadband networks.

I. Hardware Platform

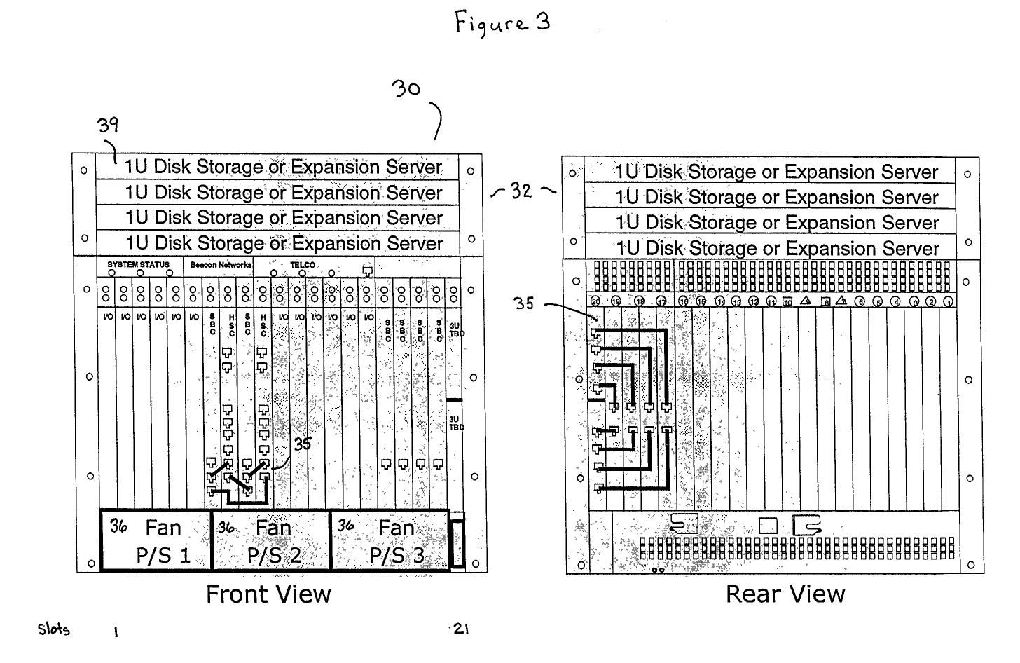

Referring to FIG. 3, in accordance with the present disclosure, the hardware platform of an exemplary PSN 30 provides the physical infrastructure needed to support cPCI SBC's and I/O cards required for “CO Grade”deployments. A preferred embodiment uses a 21 slot chassis system with standard CompactPCI board slots in the front and standard CompactPCI transition modules in the rear. The backplane for the 21 slot chassis may consist of three subsystems: the first 16 slots comprise the first subsystem, the next four are divided up into two smaller subsystems, each having a host processor slot (slots 17 and 19), and an I/O slot (slots 18 and 20) while the remaining 21^{st} slot has power on it with passive PCI connections. Slot 21 may be further divided into two 3U slots that, as referred to herein, will be called “slot 21”and “slot 22”. In addition to these 21 slots, the PSN 30 (and its chassis) may also include several expansion slots as illustrated in FIG. 3. These expansion slots may be populated by additional modules as needed or may include data storage means (e.g., disk storage) for storing subscriber profile information, configuration maintenance records, look up tables, etc.

In a preferred embodiment, the hardware platform of the PSN 30 addresses the following requirements:

A 19 inch rackmount chassis with rear transition cage;

An Alarm Panel and Power Input Module;

Triple redundant hot-swappable Power Supplies;

Special Backplane Configuration: 16 slots are optimized for packet (e.g., call) processing. The remaining 5 slots are divided up into two smaller subsystems, each having a host processor slot (slots17 and 19), and an I/O slot.(slots 18 and 20). The 5^{th} slot (3U slots “21”and “22”) only has power and Serial Management Busses on the standardized locations for cPCI J1connectors.

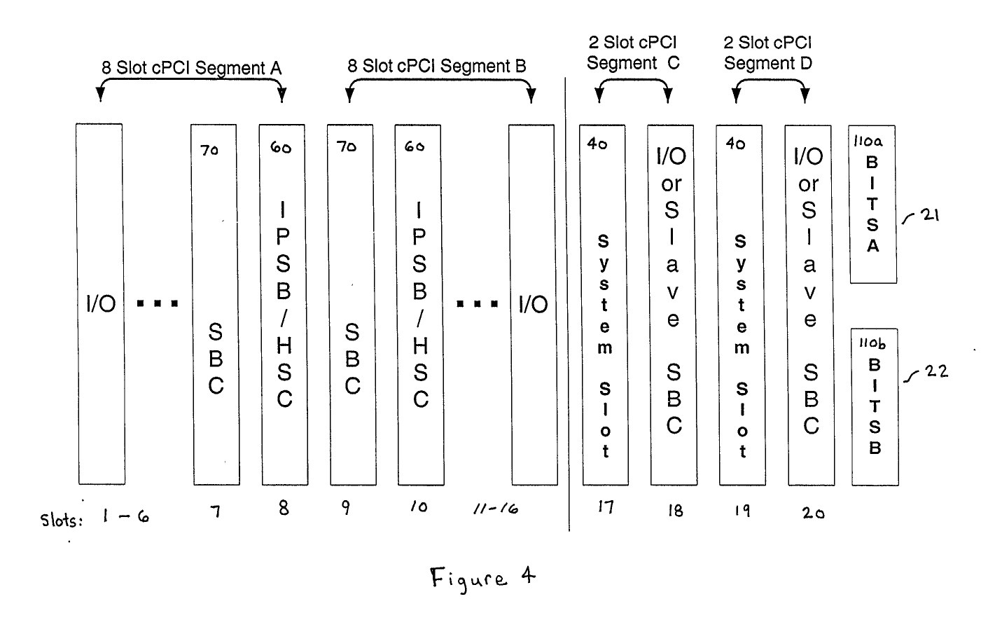

FIGS. 3 and 4 illustrates a preferred chassis 32 and cPCI card location arrangement. An alarm panel 34 is located at the top of the front panel. Three hot-swappable power supplies 36 are accessible at the bottom of the front panel. Owing to resource limitations in internal Ethernet links, certain Ethernet connections 38 may be made with external cables as shown in FIG. 3. The chassis 32 preferably is mechanically compliant with PICMG 2.0 Rev. 3.0 and applicable worldwide safety requirements and has standard 19 in. rack mount dimensions. The overall height, including a Disk Array 39 is approximately 28 in. The power supplies 36 are fed from external 48 VDC (nominal) sources.

FIG. 3 illustrates how the chassis 32 of the PSN 30 may be populated. Slots 1-6 and slots 11-16 may each be populated by a communications resource module 80 or a digital signal processing resource module 90, i.e., I/O cards, in any combination which may be deemed to be necessary to support the traffic demands being placed upon the PSN 30. Slots 7 and 9 are each populated by an access processing module 70 while slots 8 and 10 are each populated by a switching resource module 60. Additionally, slots 17 and 19 are each populated by a control processing module 40 and slots 18 and 20 each may be populated with an I/O cards or a single board computer. In a preferred embodiment, slots 18 and 20 are each populated with a signaling system interface such as the signaling system 7 interface disclosed herein. Lastly, slots 21 and 22 are each populated with a status module 110 such as the BITS/Ethernet Switch Module disclosed herein.

Backplane

FIG. 4 also shows the arrangement of the four cPCI segments on the backplane: slots 1-8 comprise segment A, slots 9-16 comprise segment B, slots 17 and 18 comprise segment C and slots 19 and 20 comprise segment D.

cPCI Slot Segments A & B

Preferably, there are two possible operational configurations for the access processing modules 70 of segments A and B: an active/passive configuration and an active/active configuration. In the active/passive configuration, a single access processing module 70 manages all twelve I/O slots (i.e., slots 1-6 and 11-16). In this configuration, the second access processing module 70 can serve as a warm standby, ready to run the twelve I/O cards (or as many as be present in the desired configuration, i.e., not all all I/O slots need to be filled) in the event of a failure on the active system. In the active/active, or load-sharing configuration, each (of the two) access processing module 70 manages six of the twelve I/O slots, much like a dual 8-slot system with the added benefit of one access processing module 70 being able to control all twelve I/O slots if the other access processing module 70 should fail. However, there may be a period of time when the six I/O slots are not being managed by either access processing module 70 (across the cPCI bus). Preferably, in a load-sharing configuration the total critical activity does not exceed the capabilities of a single access processing module 70, so that either one of the access processing modules 70 can take over the load carried by the other.

Mesh Connections

CompactPCI uses J4 for an auxiliary data transport with PICMG 2.5 or H.110 bus specifications. A preferred embodiment builds on the concept of using J4 for data transport but defines a higher speed transport mechanism. This mechanism is in the form of a high-speed network better suited for packet-oriented data.

In a preferred embodiment, the meshed network 100 is a series of point-to-point channels. These channels are wired in a meshed arranged network that connects every card slot to every other card slot in the system. The twelve I/O slots (i.e., the communications resource modules 80 and digital signal processing resource modules 90) and the two bridgeboard slots (i.e., the switching resource modules 60) are connected in the meshed network 100. The two access processing modules 70, two (or four, if these populate slots 18 and 20) control processing modules 40 and status modules 110, preferably are not.

In a preferred embodiment, each channel in the meshed network 100 is a 4-wire channel, containing a differential transmit pair and a differential receive pair. The I/O cards contain the driver/ receivers. The backplane channels of the meshed network 100 can be driven with any physical layer driver suitable for driving a copper cable. The backplane thus can be effectively a 14-by-14 network with 196 individual cables embedded in the backplane.

10/100BaseT

The backplane may provide a 10/100 Base T Ethernet connection between the access processing modules 70 in segments A and B and the (host) control processing modules 40 in segments C and D. Th 10/100 Base T Ethernet network may be partially routed on the backplane and partially cabled externally, as shown in FIG. 3. The 10/100 Base T Ethernet network may take advantage of an Ethernet switch located on the switching resource modules 60. The control processing modules 40 located in segments C and D preferably have dual rear RJ45 connectors. These may be cabled externally into the status modules 110 located in slots 21 and 22. The rear transition modules for these cards will bring the signals to the status modules 110, which contain their own Ethernet switch. Two channels from each status modules 110 can be routed on the backplane to the two switching resource modules 60 using their auxiliary ports.

To complete the network connections the access processing modules 70 in segments A and B can be cabled to the switching resource modules 60 via existing front panel connections.

cPCI Slot Segments C & D

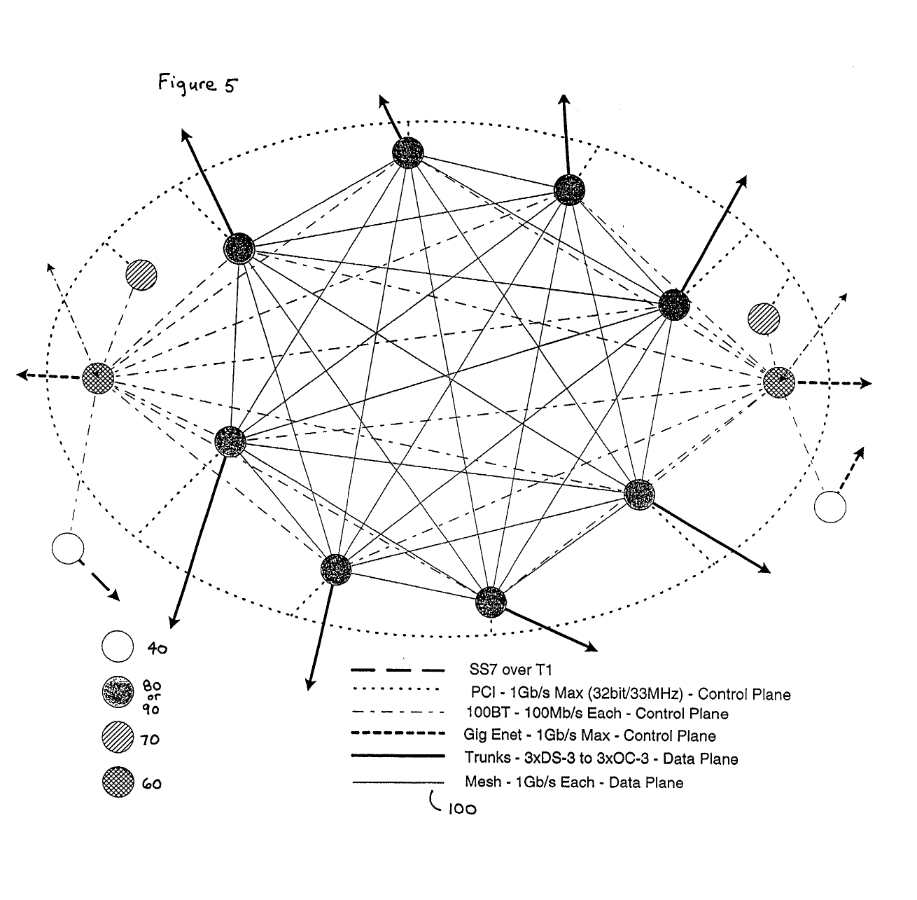

cPCI segments C and D are two-slot cPCI busses with one system slot and one I/O slot. The I/O slot is configured to permit specially enabled I/O cards (such as a SS7 interface 50, for example) and control processing modules 40 to operate with a system master card being populated. FIG. 5 shows an overlay of the data plane busses (meshed network 100), control plane busses (Ethernet 120 and cPCI 130) and external connections (GB Ethernet, T3, Ethernet, and SS7 ).

Dual Serial Management Busses (SMB) connect slots 17-20 and slots 21 and 22 per PICMG 2.9. For slots 17-20, the SMB's provide support for Solaris's management software. For slots 21 and 22, since there is no cPCI bus, the SMB's provide the minimal amount of management required by the status modules 110. This is purely a management bus and is not included in the figure above.

Access Processing Module—Segments A&B

The functions performed by the access processing module(s) 70 are those of a general purpose processor embedded within a communications framework. The work being done by the access processing module 70 (and its paired access processing module 70) controls the overall functions of the ACS 300 layer of the architecture. Specifically, the access processing module(s) 70 provides the processing capability to move bearer related content to and from the various modules within the PSN 30 to and from the other layers/modules of the PSN 30 architecture (e.g., the PCS 200, the SLEE 215, and other hardware modules). Moreover, the access processing module(s) 70 manages (preferably via the switching resource module 60) the overall flow of packet data (e.g., ATM and IP formatted calls/data) across the high speed backplane and provides the interfaces for signaling, bearer and management functions to the other PSN 30 system components. In a preferred embodiment in accordance with the present disclosure, the access processing module 70 comprises a microprocessor cCPI form factor single board computer and more specifically, in a preferred embodiment the access processing module(s) 70 is a Motorola CPX750HA series Single Board Computer. The CPX750HA is a single-slot, hot swappable CompactCPI board equipped with a PowerPC™ Series microprocessor.

Access Processing Module Rear I/O:

Rear transition modules may occupy slots 7 and 9. In a preferred embodiment, these transition modules are TMCP800-001 transition modules. The transition modules provide the interface between the access processing module 70 (i.e., a CPX750HA CompactPCI Single Board Computer) and various peripheral devices.

Switching Resource Module—Segments A&B

The switching resource module 60 provides a routing controls (e.g., switch board controls) within the ACS 300 environment as wells as a Hot Swap control function. In a preferred embodiment, the switching resource module 60 is a non-system slot, single board computer based on the PowerPC architecture. The switching resource module(s) 60 can provide a central routing resource for the control processing module(s) 40 (i.e., the Host system processors). The switching resource module 60 also provides support for the PCI interface to the Porsche chip on the dual PMC as well as the 100Base-T Ethernet I/O drivers on the switching resource module 60 via a special I/O connector. Hot swap control and power sequencing functions may be implemented with a Summit SMH4042 Hot Swap Controller. The Summit SMH4042 Hot Swap Controller may be resident in each the PSN 30 modules for controlling the powering up of each module. The SMH4042 can detect proper board insertion and ramps power to the backend circuitry with a maximum slew rate of 260V/s. The SMH4042 monitors the host supplies and both the board supply voltage and current. Voltages out of tolerance are reported to the host (i.e., the control processing module 40) with a fault indicator. If current draw exceeds the maximum threshold, power to the back end is shut down and the fault is reported. The SMH4042 also contains a serial EEPROM that is typically used to provide the PCI bridge chip its initial configuration load. The switching resource module 60 can control each module within segments A and B, i.e., can control power ups and power downs as well as moitor each I/O's “healthy”signal output.

Switching Resource Module Rear I/O

Preferably, there is no separate Rear I/O card for the switching resource module 60. The switching resource module 60 rear I/O preferably terminates on the cPCI backplane. The switching resource module 60's backplane interface uses the standard PCI connectors, locations, and pinouts.

Digital Signal Processing Resource Module

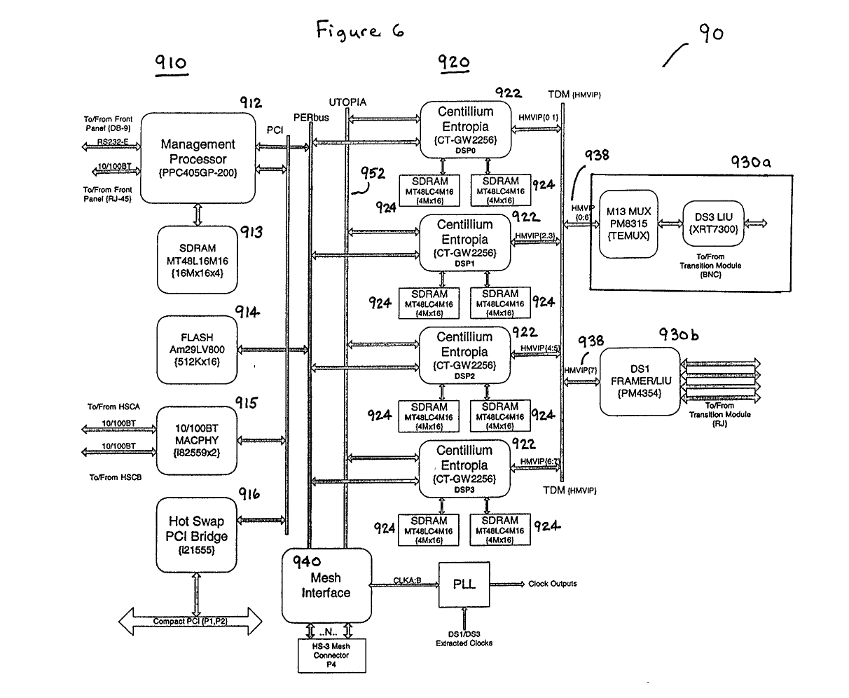

Referring to FIG. 6, the digital signal processing resource module (DPM) 90 can provide a generic hardware platform utilized for format conversion and switching of individual voice streams flowing between packet based networks and traditional circuit switched networks. The DRM 90 can receive voice channels received from the packet network, which are then buffered for de-jittering, and decompressed for transmission to the circuit switched network. Conversely, the DRM 90 can receive voice channels from the circuit switched network, which are then echo cancelled, compressed, and packetized for transmission to the packet network.

In accordance with the present disclosure, the DRM 90 preferably is a single-slot, CompactPCI card, which resides in the I/O slots of the PSN 30 backplane in the Access Control Subsystem 300. The DRM 90 can be comprised of a microprocessor based kernel for control and management, a circuit interface 930 for interconnection to an external circuit switched network, control processor module 910, a digital signal processor module 920 and a mesh interface 940.

The circuit interface 930 can be wide variety of interface devices which are capable of interfacing with an external circuit switched network. The exemplary embodiment of FIG. 6 illustrates two such circuit interfaces 930, e.g., a DS3 circuit interface 930a and a DS1 circuit interface 930b. The DS3 circuit interface 930a is preferably comprised of a PMC-Sierra PM8315 (TEMUX) high-density T1/E1 framer 932 having an integral M13 multiplexer and demultiplexer. The PM8315 is comprised of 28 individual T1/E1 framers which contain transmit and receive elastic store slip buffers, HDLC controllers in the transmit and receive paths for Facility Data Link (FDL) control or Common Channel Signaling (CCS) insertion and extraction, and signaling registers for Channel Associated Signaling (CAS) insertion and extraction. The PM8315 also contains an M13 function which provides the multiplexing and de-multiplexing of the 28 T1/E1 to/from the DS3 serial bit stream. The DS3 serial interface of the PM8315 framer 932 is interconnected to an EXAR XRT7300 Line Interface Unit (LIU) 934. The XRT7300 LIU 934 and associated magnetics provide the physical layer interface to the DS3 media. The DS3 circuit interface 930a is accessible via a BNC connector on the front-panel of the Transition Module.

As illustrated is a DS1 circuit interface 930b. The DS1 circuit interface 930b can be comprised of a PMC-Sierra PM4354 (COMET) quad T1/E1/J1 framer with an integral Line Interface Unit (LIU). The PM4354 is comprised of four individual T1/E1 framers which contain transmit and receive elastic store slip buffers, HDLC controllers in the transmit and receive paths for Facility Data Link (FDL) control or Common Channel Signaling (CCS) insertion and extraction, and signaling registers for Channel Associated Signaling (CAS) insertion and extraction. The LIU section of the PM4354 and associated magnetics provide the physical layer interface to the DS1media. Each DS1 circuit interface 930b is accessible via four RJ-11 connectors on the front-panel of the Transition Module.

In a preferred embodiment, the digital signal processor (DSP) module 920 consists of a plurality of highly integrated digital signal processors (DSP) 922 (i.e., a DSP array) each having at least one SDRAM module 924. The DSP module 920 provides the format conversion and switching of individual voice streams flowing between the packet network (e.g., ATM or IP) and the circuit-switched network (typically, TDM). Each DSP 922 is comprised of highly integrated processing engines for performing various voice compression algorithms (G.711, G.723.1, G.726, G.729A), echo cancellation algorithms, DTMF and MF tone algorithms and support for ATM AAL1/AAL2. The DSPs 922 preferably are Centillium (CT-GW2256) Digital Signal Processor ASIC's. Each DSP 922 is provided with two external 4M×16 SDRAM module 924 components for storage of switching fabric tables, received packets, TDM voice samples, echo cancellation contexts, and DSP application code. The DSP module 920 can receive voice channel packets from an ATM network through the mesh interface 940 (which may have undergone processing by a communications resource module 80), which transmits these packets to the appropriate DRM 90 via a Utopia interface 952. The DSP 922 performs the necessary buffering for de-jittering, and decompression as appropriate for the received voice channel information. The voice information is then placed into the appropriate time-slot of an HMVIP serial data stream 938 for transmission to the circuit switched (e.g., TDM) network via either a circuit interface 930.

Conversely, the DSP Module 920 can receive voice channel information from the circuit switched network via a circuit interface 930 from the appropriate time-slot of an HMVIP serial data stream 938. The DSP 922 performs the compression, echo cancellation, and packetization of the received voice channel information. The voice channel packets are then transmitted from the DSP module 920 via the Utopia interface 952 through the mesh interface 940 to the packet-based or cell-based network.

In a exemplary embodiment, the control processor module 910 includes a control (management) processor 912, a SDRAM module 913, a boot flash 914, two 10/100 Ethernet controllers 915 and a non-transparent PCI-to-PCI bridge 916. In a preferred embodiment, the control processor 912 is a PowerPC 405GP processor and the 10/100 Ethernet controllers 915 are Intel 82559ER Fast Ethernet Controller. The PPC405GP Integrated Microprocessor (IMP) provides the central processing element for the DRM 90. The PPC405GP contains a 32-bit PowerPC processor core, instruction and data Memory Management Units (MMU), 16K-byte instruction and 8K-byte data caches, high bandwidth external memory bus which supports PC-100 SDRAM, user programmable controllers for interface to FLASH 914 and other memory mapped I/O devices, programmable timers and interrupt controller, and general-purpose I/O. The PPC405GP processor core may operate at an internal clock frequency of 200 MHz and at an external bus clock frequency of 100 MHz. Additionally, the control processor module 820 may also include an IPMI controller (not shown) provide a backup messaging and control channel between the DRM 90 and the system controller, i.e., the access processing module(s) 70.

Additionally, the DRM 90 contains a mesh interface 940 for connecting to the meshed network 100. Similar to the communications resource module 80 below, the mesh interface of the DRM 90 preferably is comprised of 12 serial data transceivers (or drivers) and a mesh control field programmable gate array (FPGA). The 12 serial data transceivers can reside on three PMC Sierra 5283s backplane drivers, which transmit and receive 8B10B coded data at date rates up to 1 Gbps. The mesh control FPGA can perform the multiplexing of received packets from the meshed network 100 (e.g., channels) and transmits these packets to the appropriate DSP 922 via the Utopia interface 952. Conversely, the mesh control FPGA may also perform the de-multiplexing of received packets from the DSPs 922s (via the Utopia interface 952) and transmits these packets to the appropriate channels of the meshed network 100.

ISDN/Adjunct Services:

A Primary Rate ISDN stack can be run on the control processor 912. The stack is capable of supporting all four of the T1 interfaces of the circuit interface 930b.

E911:

Typically, one or two of the four T1 interfaces of the circuit interface 930b will be configured to support 911 service.

DSM Rear I/O:

Preferably, the Rear I/O card provides access to the DS3 and DS1 trunks only via the circuit interfaces 930.

Communications Resource Modules

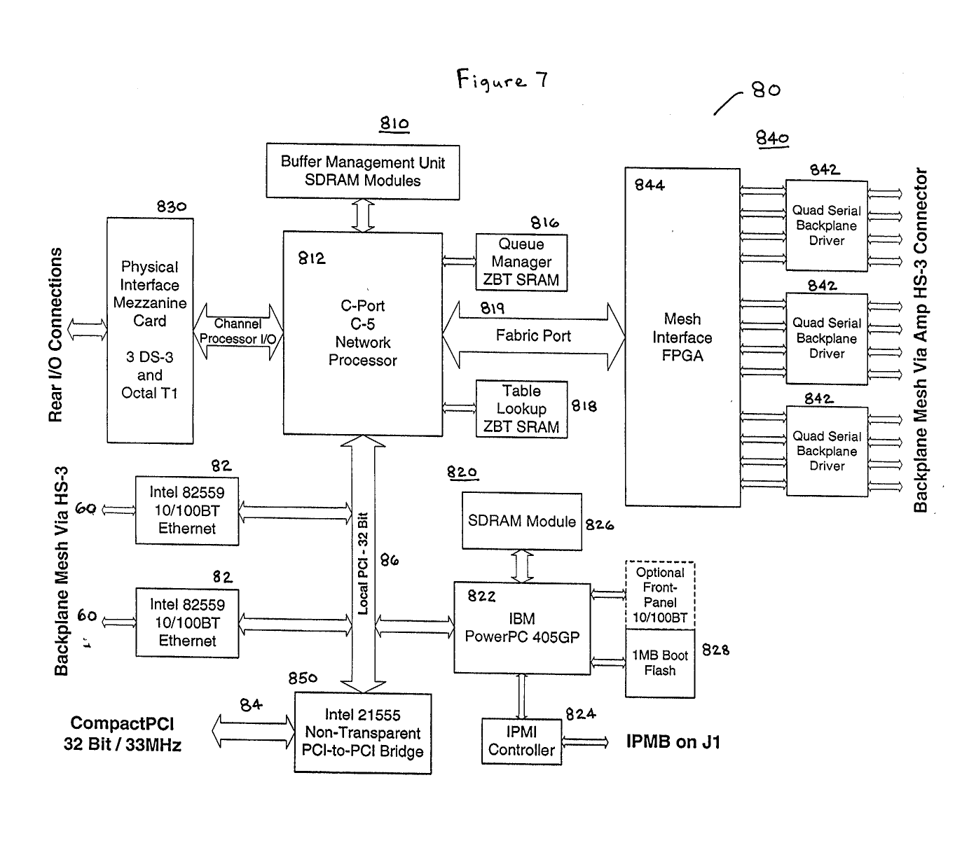

FIG. 7 illustrates an exemplary embodiment of a communications resource module 80 in accordance with the present disclosure. In some preferred embodiments, the functions of the communications resource module 80 may be performed by a Communications Resource Card (CRC). A CRC is an I/O processing card which can be installed in a chassis slot. The CRC 80 of FIG. 7 consists of a network processor module 810, a control processor module 820, a network interface 830 and a mesh interface 840. The communications resource module (or card) 80 provides a means of connecting the network interfaces 830 to the meshed network 100, which can be a meshed backplane of a chassis. The network interface 830 (or interfaces) is capable of receiving (or delivering) either cells or packets (i.e., cell-formatted or cell-formatted calls), which will then be processed and forwarded to the appropriate link of the meshed network 100. The processing of the cells and packets may include classification and forwarding, segmentation and reassembly, and in some cases, conversion between ATM and IP formats (e.g., conversion between cells and packets). Control communication (e.g., from a switching resource module 60) with the CRC 80 can occur over a 100 Base-T Ethernet line and/or the CompactPCI bus line 84.

In a preferred embodiment, the CRC 80 utilizes a PPC405GP PowerPC embedded processor 822 as a control processor (of the control processor module 820) and a network processor 812 (of the network processor module 810) that supports several network interface configurations, e.g., up to four OC-3. However, in accordance with the present disclosure, other processors may be used in other embodiments. The network interface(s) 830 of the CRC 80 may reside on a mezzanine card. In some embodiments, the mezzanine card may consist of three DS-3s and an octal T1, as is shown in FIG. 7. The CRC 80 may communicate with other processing cards (e.g., other CRCs 80 and DRM 90s 90 in the system 30 through point-to-point connections provided by a meshed network 100 interconnect on the backplane. The links of the meshed network 100 can operate up to a 1 Gb/s rate, which provides high bandwidth channels well suited for packet and cell transmission.

The network processor module 810 may consist of a C-Port C-5 network processor 812 and a buffer management module 814, a queue manager module 816 and a table lookup module 818, which may be required by the network processor 812. The buffer management module 814 may provide an SDRAM controller that allows for external SDRAM memory that is used for temporary cell and packet storage. The amount of memory required is application specific, which depends on the cell/packet bandwidth through the chip as well as the type of cell/packet processing that is being performed. The SDRAM interface is 128 bits wide which requires eight 16 bit wide SDRAM components. Th configuration may use 4 Mb×16 parts for a total of 64 MB. The table lookup module 818 can provide the channel processors with routing and classification information. The table lookup module 818 may support up to four banks of up to 32 MB for a total of 128 MB of ZBT SRAM. The CRC 80 can provide two banks of 4 Mb SRAM for a total of 8 MB. Once 16 Mb ZBT SRAM parts are available, it will be possible to increase the total to 16 MB. The queue manager module 816 may provide the mechanism by which cells/packets are queued for delivery to their next destination (either a channel processor or the fabric port 819).The queue manager module 816 may support up to 512 KB of external ZBT SRAM. The CRC 80 can support the maximum configuration by using a single 4Mb (128K×32) SRAM part.

The network processor 812 can be capable of processing both packets and cells from the network interface(s) 830 and forwarding these packets/cells to their proper destination (e.g., on the meshed network 100). Additionally, the network processor 812 can be able to convert between packet and cell formats as well as provide other cell and packet manipulations. A processing element that was capable of providing all of the required packet and cell processing was chosen. For this task, a network processor was identified as the best fit. The C-Port C-5 was chosen because of its high integration and channel processor architecture that provides framer and cell/packet delineation. The depicted C-5 network processor 812 contains 19 specialized RISC processors along with other dedicated processing elements. The network processor 812's functional elements include channel processors (CPs), executive processor (XP), queue management unit, table lookup, buffer management unit, and a fabric port 819. There are 16 Channel Processors, which can each handle up to an OC-3 bandwidth. The channel processor is a combination of a micro-engine that performs bit wise serial processing and a RISC processor that performs byte level header analysis and packet/cell queuing. Each channel processor (CP) in the C-5 network processor 812 has seven I/O interface pins. The channel processors can be grouped into a cluster of four to provide combined processing for high rate interfaces such as OC-12 and gigabit Ethernet. The I/O signals for two clusters of CPs (0-7) can be routed to the mezzanine connector (of the network interface 830) where they can connect to the T1 and DS-3 framers and then to the rear Transition Module (TM). A gigabit EWthernet transciever may be located on the TM. The I/O signals for other clusters (CPs 8-11) can routed to the J3 CompactPCI connector. These can be used for connection to OC-3 or to a second gigabit Ethernet optical or copper transceivers on a rear I/O card. The executive processor may provide control over all the elements in the network processor 812 and communicates with the control and management processes over a PCI interface 86.

The fabric port 819 is similar to a channel processor, but has less bit level capabilities as a trade-off for a higher I/O bandwidth (4 Gb/s). The fabric port 819 can be configured as a 16-bit level-3 utopia interface that connects to the mesh interface 840. The mesh interface 840 may have serial backplane drivers 842, or SERDES, and an field programmable gate array (FPGA) 844 that interfaces the SERDES channels to a Level-3 Utopia interface with only single phy capabilities. The Utopia interface uses the Virtual Path Identifier (VPI) to determine which backplane link a cell (or packet) will be sent over. The serial backplane drivers 842 to drive the meshed serial backplane links 844 (of the meshed network 100) can be driven by a plurality of PMC-Sierra PM8353 QuadPHY Gigabit Ethernet Interfaces. Each QuadPHY part provides four individual serial channels operating at 1.25 Gbps. The PM8353 supports standard Gigabit Ethernet operation along with Physical Coding Sublayer (PCS) logic. It is a low power device consuming a typical 1 watt for all four channels. It also provides individual channel loopback, BIST and packet generation and checking logic to simplify operation verification.

Network processors, especially the C-5 network processor 812, are highly integrated devices that consume a large amount of power. The C-5 network processor 812, running at its full bandwidth capability, may dissipate up to 15 watts. The power requirements of the network processor 812 results in a tight power budget for the rest of the components on the CRC 80. This was a major factor that drove the architectural decisions for the remainder of the board. Additionally, the CRC 80 functions can require a significant number of components, which makes available real-estate the second major architectural criteria. The arrangement of the CRC 80 as disclosed herein were made to satisfy these criteria as best as possible.

As stated, the network processor module 810 provides the cell and packet processing that is the major functional task of the communications resource module 80. On the network side, the network processor module 810 connects to framers and physical interfaces that will be located on a network interface(s) 830, e.g., rear TM and the mezzanine card. And on the system side, the network processor module 810 connects to the mesh interface 840. In a preferred embodiment, the mesh interface 840 uses high speed serial transceivers to communicate with other I/O boards, i.e., other communications resource modules 80 and digital signal processing resource modules 90, via the point-to-point links of the meshed network 100. The mesh interface 840 may utilize a Level-3 Utopia interface that connects to the network processor module 810. The Utopia interface uses the Virtual Path Identifier (VPI) to determine which link to transmit a cell or packet.

The embedded processor 822 can act as a control processor, which can communicate to other devices in the system via a 100 Mbs Ethernet 82 or the CompactPCI bus 84. The embedded processor 822 is responsible to process and exchange management and control information between the network processor 812 and the access processing module(s) 70 (directly or via a switching resource module 60). In addition to the control processor 822 (e.g., embedded processor), the control processor module 820 may also include an IPMI controller 824 to provide a backup messaging and control channel between the CRC 80 and the system controller, i.e., the access processing module(s) 70. The IPMI controller 824 can be implemented with a MicroChip PIC processor. This processor is responsible for monitoring board temperature, power supply status and operational status. It responds to status inquiries from the system controller, and will generate messages to the system controller to report errors and other operational data.

The control processor module 820 is responsible for processing control and management information and forwarding the appropriate command to the network processor module 810. The control processor module 820 may communicate with all of the major components of the CRC 80 via a local PCI bus 86. Additionally, the control processor module 820 may control the framers on the network interface 830 via 8 bit peripheral bus (not shown). In a exemplary embodiment, the control processor module 820 includes a control processor 822, a SDRAM module 826 and a boot flash 828, two 10/100 Ethernet controllers 82, a non-transparent PCI-to-PCI bridge 850 and an IPMI controller 824. In a preferred embodiment, the control processor 822 is a PowerPC 405GP processor and the 10/100 Ethernet controllers 82 are an Intel 82559ER Fast Ethernet Controller. The PPC 405GP, at an estimated $60, is the lowest cost processor in its category. The real-estate saving integration, low power, and low cost make the PPC405GP the best choice for a control processor in the 300-400 MIPS range. The Intel 82559ER Fast Ethernet Controller was chosen to provide the 100 Mb/s Ethernet interfaces 82 because of its small footprint (15 mm square) and its driver availability. The non-transparent PCI-to-PCI bridge 850 provides connection between the local PCI bus 86 and the CompactPCI bus 84. It supports the CompactPCI hot swap requirements and contains the necessary circuitry for control of the hot swap LED and ejector handle switch. A non-transparent bridge is required so that the on-board peripherals are not discovered by the system controller. Instead, the CRC 80 appears as a single PCI device.

For line interfaces, preferably, three clear channel T3 connections are provided by a daughter card. The same daughter card can support two or four clear channel T1's dependent on internal resources. Inverse Multiplexing over ATM (IMA) preferably is not supported on these T1 trunks. Additionally, preferably, the Rear I/O card provides access to the T3 and T1 trunks only.

Clock Generation:

The PowerPC 405GP control processor 822 is clocked by a 33.3 MHz oscillator. Internally to the PPC405GP, this clock is multiplied by several units, which provide the internal core clock, the SDRAM clock, and the PCI bus clock. The core clock is set to either 199.8 MHz or 266.4 MHz, depending on the speed grade of the processor. The PCI bus is clocked at 33.3 MHz and the SDRAM clock can be either 99.9 MHz or 133.2 MHz depending on the speed grade of the SDRAM DIMM. The C-Port C-5 network processor 812 requires a 400 MHz LV-PECL clock, which it internally divides to provide various clocking for its functional units. The C-5 also requires an external clock for its Table Lookup ZBT SRAM 818 and the SDRAM 814. The Queue Management ZBT SRAM 816 is clocked at ½ the C-5 core frequency. The Mesh interface drivers (SERDES) 842 require a 125 MHz clock that is multiplied internally up to the 1.25 GHz serial line rate. The FPGA 844 also uses this clock for transmit and receive bus timing. Additionally, the FPGA 844 derives a 60 MHz clock from the 125MHz input for Utopia timing. The mesh backplane (e.g., meshed network 100) provides for redundant bussed clocks intended for network interface clock distribution. The CRC 80 is capable of using these clocks when a network interface is configured as clock master. CRC 80 can also drive one or both of the backplane clocks by recovering a clock from any clock slave network interface.

Status Module

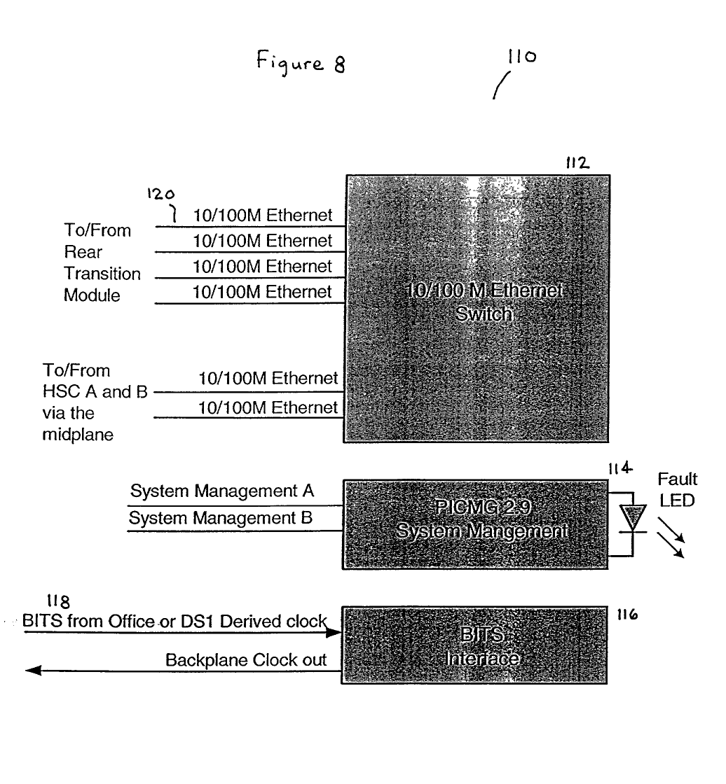

In a preferred embodiment in accordance with the present disclosure, the status module 110 (sometimes referred to as BITS/Ethernet Switch Module (BITS/ES)) can be a 3U size card which provides accurate and stable timing for the system 30, which is generated internally and can be synchronized to an external BITS reference input via link 118. Two status modules 110 may be populated in each chassis (i.e., system 30) for redundancy. FIG. 4, for example, illustrates a system 30 having two status modules 110 located in slots 21 and 22. Referring to FIG. 8, the status module 110 provides the Building Integrated Timing Source (BITS) for certain central office environments, plus a second level of Ethernet Switching for the redundant connectivity of all modules (e.g., cards) in the PSN system 30 and may additionally provide redundant ports for external management systems, as shown in FIG. 8. The BITS function takes a physical clock (per GR-1244-CORE 3.2.1 R3-1) present in the facility and distributes this timing reference to all other modules in the system 30 having external trunks. The clock circuitry of the status module 110 preferably meets Stratum 3 requirements.

The status module 110 also has an eight port Ethernet switch 112 which can provide connections between the control process modules 40 (in domains C and D) to the switching resource modules 60 (in domains A and B). The Ethernet switch 112 can provide maintenance and control Ethernet connections 120 between these modules. The 8 port Ethernet switch (unmanaged) 112 preferably is a single chip self-contained device. In a preferred embodiment, the Ethernet switch 112 is a Broadcom BCM5317 Ethernet switch.

The status module 110 may also contains a “PIC” micro controller 114, which controls the Stratum 3 oscillator as well as providing Fault and Ready LED indicators. The PIC micro controller 114 may also be used to monitor the temperature of the modules within the system 30. The PIC micro controller 114 may be connected to the rest of the system 30 modules by a serial data bus, e.g., an Inter Processor Maintenance Bus. The serial bus may be used to communicate with the single board computers (e.g., the control processing modules 40 and access processing modules 70) to receive commands and transmit status back to them. The PIC micro controller 114 is responsible for controlling the Red Fault LED and Green Ready LED. The PIC micro controller 114 is responsible for monitoring and controlling the switching resource modules 60. The switching resource modules 60 Healthy and Fault signals can be read by the PIC. It can also Reset the switching resource modules 60 as well as Enabling it. The switching resource modules 60 has a small amount of nonvolatile memory built into it and the PIC micro controller 114 can access this memory through the same serial bus as it does the temperature sensor. The PIC micro controller 114, in some embodiments, can be programmed in the system 30 through the (J3) PIC Programming header.

The Stratum 3 oscillator will produce a 19.44 MHz output that, under software control, can be sent down the backplane for use by the I/O cards in slots 1-6 and 11-16 as their Telco timing reference. The oscillator provides an alarm output that must be monitored by software to determine if a switch over is needed from the reference to holdover mode.

Status Module Rear I/O:

A single 6U rear transition card preferably is used by both of the 3U front cards. The rear I/O preferably contains screw terminal connections for two Building Integrated Timing Source (BITS) feeds and ten (or 12) RJ45 100 Mb Ethernet connections.

Control Processing Module—Segments C&D

The control processing module 40 provides the basic processing capacity for all PCS 200 based functions within the PSN 30 architecture. In a preferred embodiment, the control processing module 40 is SPARC-based CompactCPI form Single Board Computer that is designed for high performance embedded applications. A suitable SBC is the Leopard UltraSPARC cCPI SBC available from the Momentum Computer, Inc. The control processing module 40 card accepts information flowing bidirectionally from the SLEE 215 and from the ACS 300 layers. External access to all system management functions (e.g., logging, monitoring and management, SS7 protocol interfaces, local craft interface) may be is exposed through this module (i.e., processor card). Additionally, the control processing module 40 is the physical embodiment of the call agent/call control functions that provide the ability to apply features and treatments to individual call sessions/streams being processed by the PSN 30. Higher level service functions (applications/services that execute within the framework of the SLEE 215) may be executed within the control processng module 40 as well. Basic call feature related functions (digit collection, tones, announcements, record and play) are exposed through the call control processes within the PCS 200 and directed within the control processing module 40 for treatment by applications.

Signaling System 7 Interface

The signaling system interface 50 can provide signaling system 7 (SS7 ) connectivity. The signaling system interface 50 preferably is provided by a Motorola MPMC8270 which may be carried on the control processing module 40. This PMC module has been designed to provide network interface functionality for E1 or T1 lines on a single slot PMC format. The MPMC8270 module is a standard PCI Mezzanine Card Type 1.

Disk Array

The disk array(s) 39 can be Sun D130 which provide a minimum of 18 GB (each) of disk space and three Sun D130 can provide 54 GB of storage in 1U rack height.

II. Software Architecture

Platform Control Subsystem Software

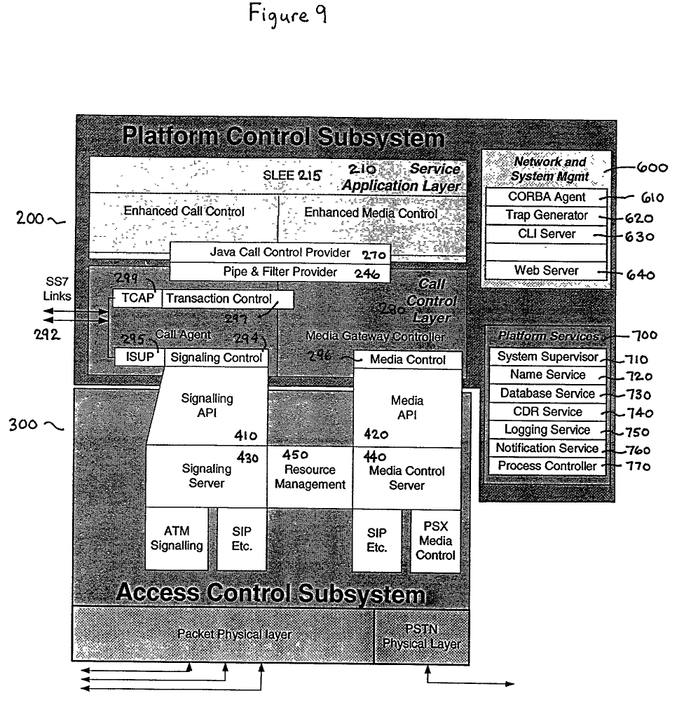

FIG. 9 illustrates a high level view of one embodiment of the software architecture of an exemplary PSN 30. In an exemplary embodiment according to the present disclosure, the PCS 200 can consists of a service application layer 210 for facilitating call processing services, a call control layer 280 for providing basic originating and terminating call models and an object-based execution environment for processing calls and a call control interface 270 which bridges the service application layer 210 and the call control layer 280. The service application layer 210 provides support for enhanced and custom call processing services. The service application layer 210 is logically layered above the call control layer 280 and can include building blocks for building enhanced services. For example, access to the PSN 30 database (i.e., disk array 39) can be provided to allow services to use the address translation and common routing tables 287 that may be located there.

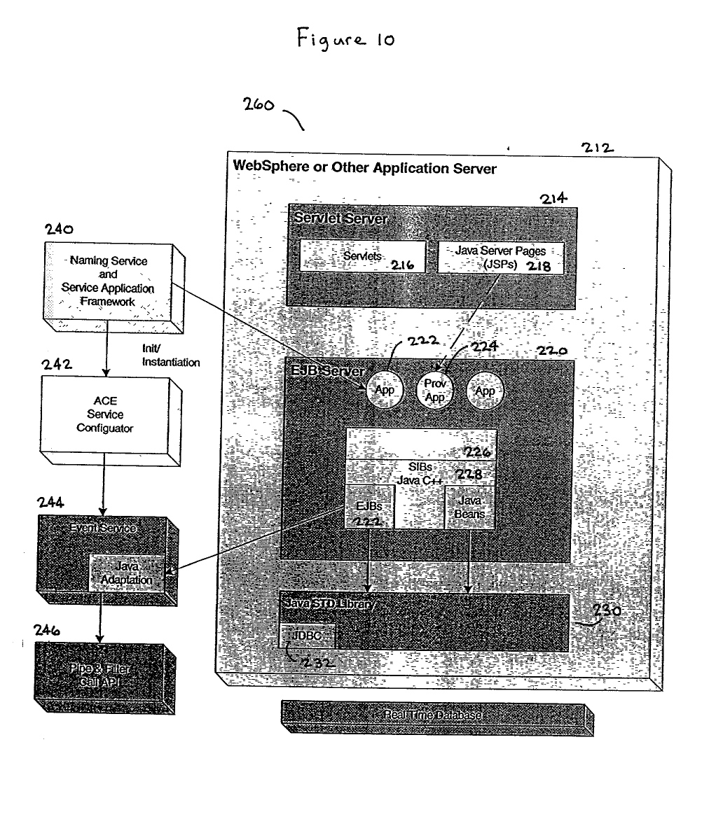

Referring to FIGS. 9 and 10, the service application layer 210 comprises an application server 212 hosting a service logic execution environment (SLEE) 215. The application server 212 preferably includes a servlet server 214 and an Enterprise JavaBeans (EJB) server 216. In a preferred embodiment, the SLEE 215 can provide support for enhanced call processing services and have access to the servlets 216 and the Java Server Pages (JSP) 218, which reside on the servlet server 214, and the Enterprise JavaBeans (EJB) 222, which reside on the Enterprise JavaBeans server 216. In a preferred embodiment, the SLEE 215 is a JAIN-based (Java API for Integrated Networks) execution environment that provides enhanced and custom call processing services, and includes support for services developed by a Service Creation Environment (SCE) and provisioned by an external Service Provisioning Environment (SPE).

SCE is an intuitive, Java-based, rapid application development/deployment (RAD) environment in which network services and their customer access points are developed and modified for later deployment to the SLEE 215. The SCE is also used to create provisioning applications for use in the Service Provisioning Environment (SPE). Running separately from the rest of the PSN system 30 software, the SCE consists of a Windows NT workstation running the appropriate Java design facilities. By using Web-based authoring tools and integrated development environments (IDEs), the SCE allows service developers to use and construct components called service-independent building blocks (SIBs) to accomplish complex telecommunications and Web-based services. In addition, the SCE provides security, telephony, media, and signaling models through the Java Community Process API definitions and implementations.

The SPE is a password-protected, Web-based application framework for executing userdata provisioning applications. The SPE allows users to set up their own telecom features via a standard Web browser or microbrowser without the assistance of a customer service representative (CSR). Users can also subscribe/unsubscribe to various services that are available from their service provider such as Call Forwarding, Call Blocking, and Call Waiting. Users can also set options for services to which they have subscribed (for example, a user can change the telephone number to which incoming calls are forwarded). The SPE application consists primarily of servlets 216 to provide the program logic and Java Server Pages (JSPs) 218 to provide the presentation logic.

Returning to FIG. 9, call services within the SLEE 215 can interact with the basic originating and terminating call models in the call control layer 240. The SLEE 215 logically resides above the call control layer 240 and is an open environment, which means that the call processing and service layers of the PSN system 30 can be controlled by an alternative execution environments. Therefore, customers, for example, can develop their own Java-based service execution environments or C++ based support for legacy telephony applications. The SLEE 215 can abstract all the complexity and connectivity for an enhanced service thereby making the service itself easier to develop. At its core the SLEE 215 acts as a web application server which has access to the web based technologies such as servlets 216, JSPs 218, and EJBs 222. Added to this infrastructure is a SLEE container. The SLEE Container abstracts the underlying protocols used for processing (phone) calls. The SLEE Container also can handle the threading of each of the service instances. Threading is important for the container to manage because can simplifies the structure of the Service (e.g., a newly developed enhanced service that is to be implemented into the PSN 30). By handling the interface to the telecommunications infrastructure, the SLEE container allows services to span multiple networks and take advantage of truly converged networks. This is where instant messaging and standard phone calls in the PSTN may be combined to create new services not possible on the PSTN alone, such as enabling an instant message, with the Caller ID and the Caller Name, to be sent to a user's computer for every phone call sent to the user's telephone, for example. This type of enhanced call service can be accomplished by the PSN 30 disclosed herein because the Service can use APIs (i.e., signaling control API 410 and media control API 420) exposed by the SLEE 215 to extract information from the ISDN User Part (ISUP) message, form a Transaction Capabilities Application Part (TCAP) query to extract caller name (both SS7 network operations) then package that information as a Session Initiation Protocol (SIP) or AOL instant message bound for the user's computer (an IP Network operation).

In a preferred embodiment in accordance with the present disclosure, the SLEE 215 can support third-party service logic programs (SLPs). SLPs can run entirely within the PSN system 30 and can access the local database tables within the disk array 39, if desired. SLPs can also run outside the PSN system 30 on an Service Control Point (SCP) and be accessed through TCAP transactions. Examples of common SLPs are service deployment, service management, usage monitoring, and error and trace logging, amongst others.

Services may participate in call processing when they become activated at various trigger/detection points within the originating and terminating basic call models. When the basic call state machine processes events they are first delivered to each active service that has been instantiated for the call. The service then has an opportunity to process the event and control the subsequent flow of the basic call state machine. For example, the service can pass the event on to another service or it can substitute the given event for a new event and request that the basic call reenter the state machine at a new state.

Isolation between the call control layer 240 and the service application layer 210 is desirable since new services may be developed by customers and this isolation of the layers may preserve the integrity of the call processing software (i.e., the call control layer 240) by avoiding “contamination”or the corruption of data and state due to errant service logic. Additionally the implementation language of choice is likely to be different for these two components with Java preferably being used at the service application layer 210 due to Java's rich development environment and run-time safety properties while C++ is preferably being used at the call control layer 240 for its performance advantages in the processing of basic call services.

The servlet server 214 may invoke servlets 216 based on the URL it receives from the application server 212. Servlets 216 generally are server side Java programs that run when a browser or program makes a connection through the application server 212 to the servlet 216'sURL. Servlets 216 are the server-side components of the SPE. Servlets 216 contain the majority of the application logic and are particularly adept in providing dynamic content to a client. User input is passed between servlets 216 and JSPs 218 to allow for persistent session tracking. The Java Server Pages (JSP) 218 of the servlet server 214 are html scripts with embedded java code that can get compiled into a java servlet when their URL is requested. The Java Server Pages 218 are the server-side components that are responsible for generating user presentations. They retrieve HTTP session objects, which hold information placed into them by the servlets 216, from a cookie placed on the client's machine. The JSP 218 then uses that information to generate dynamically the content seen by a user. JSPs 218 are the only part of the SPE with which the users ever have contact. By using a JSP 218, a programmer can separate content from presentation. The Enterprise JavaBean (EJB) Server 220 is a server that supports remote access to the underlying Enterprise Java Beans 222 (Server side components). The EJB server 220 can assist in providing multi-tier client/server applications. The applications 222 depicted in the EJB server 220 are application programs which are created with the Service Creation Environment and deployed to SLEE 215 server platform (i.e., the application server 212 hosting the SLEE 215). The provisioning applications 224 depicted in the EJB server 220 are Applications that have to do with modifying customer data in some fashion (e.g. setting a new call forwarding number). The Pelago Beans 228 are the set of components application that developers can use to create services. The Service Independent Building Blocks (SIBs) 228 are beans which map directly to similar functionality specified in Telecordia specifications while the Enterprise JavaBeans (EJBs) 222 are server side java beans that aid in the development of multitier applications. Additionally, the Java Standard Library 230 is the library that comes standard with each Java Virtual Machine and Java Development Kit and the Java Database Connectivity API (JDBC) 232 is the standard API to use when accessing a database.

In a preferred embodiment, the service application layer 210 of the PSN 30 supports the following: a Naming Server and Service Application Framework 240, an ACE Service Configurator 242, an Event Service 244 and a call control API 246. The Naming Server and Service Application Framework 240 is used by Applications to locate the set of EJB's needed for their runtime environment. The Service Application Framework assists in the deployment and instantiation of C++ based services. The ACE Service Configurator 242 is a design pattern from the ACE library that allows services to start up and shut down without having to stop any other services. The Event Service 244 allows applications to subscribe to events coming from the underlying call API, and the Call control API 246 is the call control-side interface found between the service application layer 210 and the call control layer 280.

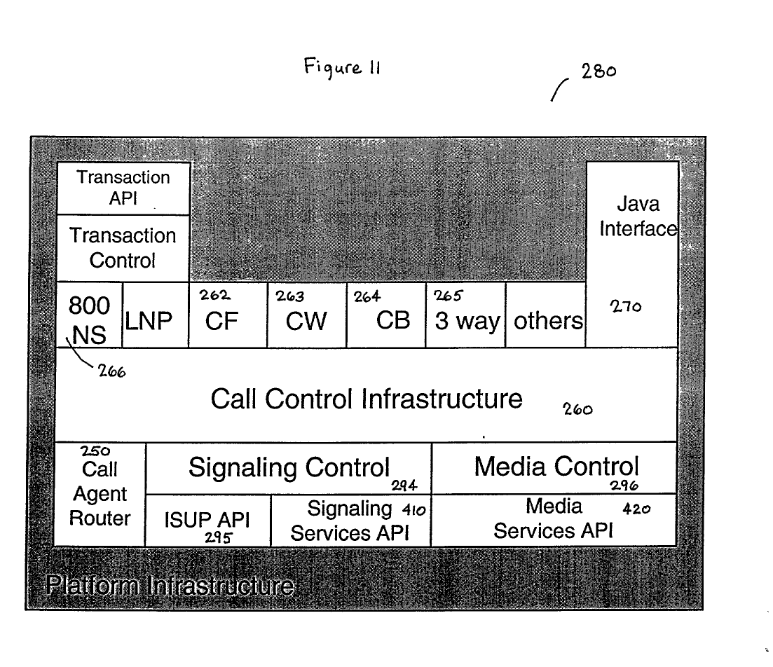

Referring to FIGS. 9 and 11, the call control interface 270 can serve as a bridge between the call model supported within the preferably Java based service application layer 210 and the call control infrastructure 260 of the call control layer 280. In a preferred embodiment, the call control interface 270 is a Java interface which can transmit Java Service Layer events to the call control layer 280 and connects services (flowing from the call control layer 280) for a given call to the SLEE 215. The call control interface 270 can translate Java Service Layer events that arrive from the SLEE 215 into signaling messages and sends them to the appropriate signaling process. For a given call, the call control layer 280 routes a software connection to the Java interface object when it detects that the call employs a service provided by the Java Services environment. A call agent router 250 then routes a filter connection to the Java Interface object when it detects that the current call employs a service provided by the Java Services environment. The main responsibilities of the call control interface 270 are to: translate call control infrastructure 260 signaling messages received at the object to Java Service Layer events (e.g., JTAPI) and deliver these from the C++ environment to the Java Service Logic Execution Environment; translate Java Service Layer events that arrive from the SLEE 215 into call control infrastructure 260 signaling messages and send them out the appropriate call control infrastructure 260 signaling port; and to maintain a correspondence between Call Control infrastructure 260 signaling ports and endpoint objects in the Java Services Layer.

The call control layer 280 preferably may contain call services such as call forwarding 262, call waiting 263, call back 264, three way conferencing 265, “800”number lookup 266 and other translation based services, and other similar services. The interface to/from the PCS 200 and the ACS 300 is through the signaling API 410 and the media control API 420 which interact with the Signaling Element 430 and the Media Control State Machine 440, respectively, in the ACS 300. The interface to the service application layer 210 is via the call control interface 270, as discussed above.

The call control infrastructure 260 of the call control layer 280 may implement features for a given call into dedicated software processes that then process that call's signaling events. The software processes are state machines that are dedicated to a call control function such as address translation, trunk group selection, and so forth. The software processes may also be fault tolerant so that, in the event of a hardware or software failure, the PSN system 30 can re-route the call. The software state machines required for a given call share their critical data, which is then aggregated into a call record 284. The call record 284, in turn, facilitates several processes, including sharing of data between state machines, call recovery, and generation of billing records. A new call record 284 is created whenever a trunk receives an initial setup indication for a call or whenever a state machine initiates a new call. In addition to maintaining call state, each call record object produces a call detail record (CDR) that provides detailed information about the call necessary to produce billing records. The CDRs can be sent to a collection service that records these records on disk for subsequent offload to a back-end billing media service. A call table can reside in the call control layer 280. The call table may manage the set of active calls in the system 30 and provide the mechanism by which the state of a stable call is preserved. For recovery, the critical states of each call may be recorded by the call table and aggregated into a call record. The call control infrastructure 260 contains two interfaces to the lower software layers in the ACS: a signaling control API 410 and a media control API 420.

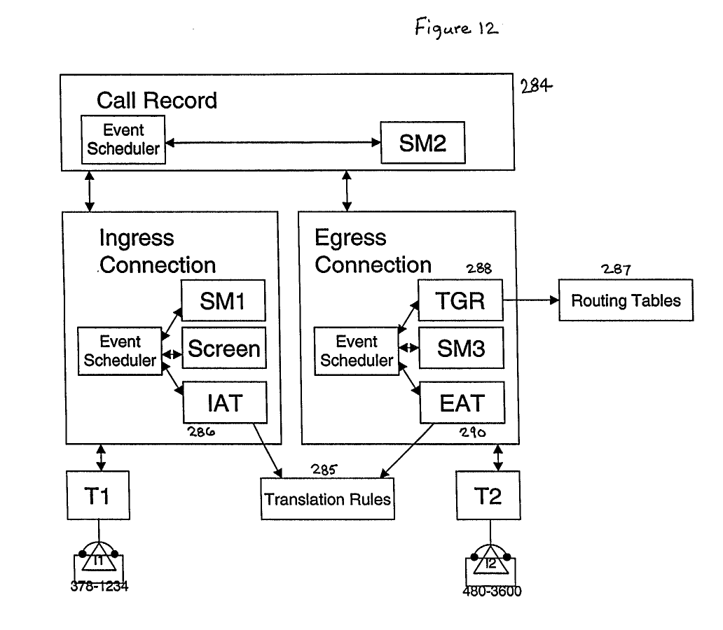

The call control layer 280 preferably implements the features for a call as state machines that process call signaling events. The state machines that apply to a call are bonded together via pairs of signaling interfaces that provide for message exchange between adjacent state machines. Each state machine implements a state machine specific to its function, such as Address Translation, or Trunk Group Route Selection. For example, in FIG. 12, the state machine label IAT 286 may provide ingress address translation that manipulates the incoming calling and called party addresses according to translation rules 285 associated with the ingress trunk. The state machine labeled TGR 288 may then select the egress Trunk Group based on routing information contained in the routing tables 287. The TGR 288 state machine may be responsible for rerouting the call in the case of routing failures. The state machine labeled EAT 290 may apply egress address translation according to translation rules associated with the egress trunk group. The set of state machines supporting a call are aggregated and managed by a call record 284 that facilitates state sharing between state machines, call recovering, and billing. A call record 284 may be created for a call whenever a trunk (e.g. T1 292 in FIG. 9) receives an initial setup indication for a call, or whenever a state machine initiates a new call.

The call table preferably is responsible for managing the set of active calls in the PSN 30 and provides the mechanism though which the state of stable calls is preserved. At critical state transitions a state machine records its state with its call record in the call table. The call record 284 is then responsible for storing the entire state of a call using a recoverable storage area. Recoverability may be provided via a backup Call Table that maintains a shadow copy of the call records in the primary Call Table. In addition to maintaining call state, each call record object produces call detail records (CDR) which provide detailed information about the call necessary to produce billing records. These CDRs may be sent to a collection service stably records these records on disk for subsequent offload to a back-end billing media service.

In a preferred embodiment, the call control layer 280 includes a signaling control module 294 and a media control module 296. The signaling control API 410 and media control API 420 of the call control layer 280 are coupled to the ACS signaling control processes 430 and media control processes 420, respectively. In a preferred embodiment, the PSN system 30 disclosed herein can support both ISUP and ATM signaling controls. In an exemplary embodiment, the PSN system 30 supports SS7 ISUP-based signaling via an ISUP protocol agent 295. The ISUP protocol agent 295 can communicate with and exchange signaling messages with the lower layers to perform call setup, call teardown, and circuit maintenance. The ISUP protocol agent 295 may interface directly with a third party SS7 stack via links 292. The ISUP protocol agent 295 is responsible for creating the Trunk Interface objects that support the SS7 circuits handled by the agent.

ATM signaling controls provide the client side of the signaling protocol used for setting up and tearing down ATM-based calls. This software (within signaling control module 294) can be used to send and receive call signaling messages from the underlying PSN switching hardware. The server side(s) of this protocol preferably lives either on an ATM card or on a switch control processor. Candidate protocols for this interface include an ISUP or Q.931 variant, Q.2931, UNI 4.0 signaling protocol. Interaction with these protocols residing on the Access Control Subsystem 300 are through the Sig Services.

The call control infrastructure 260 may present an abstract call model to the media control module 296. The media control 296 may be responsible for encapsulating the details of establishing a path for voice and data between the logical ports (ingress and egress) used for a call and may provides an API (i.e., media control API 420) for creating and deleting connections, while also supporting the ability to establish media connections with special resources in support of announcement playback, digit collection, and so forth. The call control infrastructure 260 can present an abstract call model to the media control API 420. This model consists of richly featured “real”endpoints (DSOs, CICs, VCCs, etc.), featureless virtual inter-connect “channels,”and “virtual”endpoints. The media control 296 process can isolate the call control layer 280 from the detailed implementation of the media control API 420, thus allowing for customized APIs to be implemented in future releases of the PSN system 30. The media control API 420 can send call setup/teardown commands as well as forwarding table update commands to the underlying hardware. These commands are then sent over the backplane to the appropriate digital signal processing resource module 90 or communications resource module 80. In exemplary embodiments, the media control API 420 may be a MEGACO, MGCP, or proprietary interface.

In a preferred embodiment, the call control layer 280 also includes a transaction control (TCAP) module 297 which utilizes a TCAP interface 299. Access to TCAP services therefore may be placed, via SS7 links 292, through the TCAP interface 299 object that is accessed by the state machines that implement the TCAP-style features, such as 900 number lookup for example.

Network and System Management

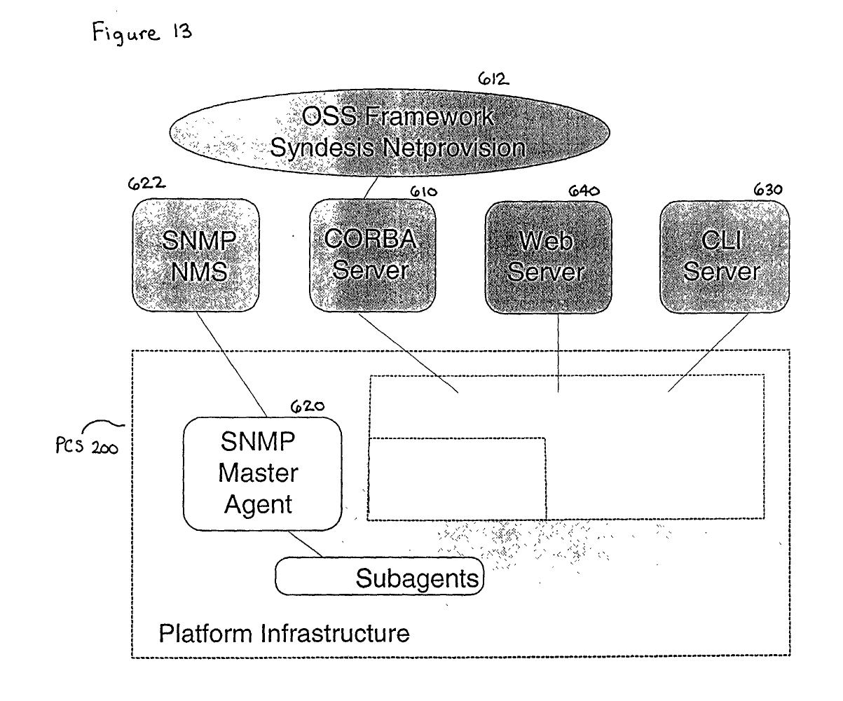

In a preferred embodiment, the PSN 30 may further include a network and system module 600. However, in certain exemplary embodiments of a PSN 30 in accordance with the present disclosure, the network and system module 600 may not be present. A preferred embodiment of a network and system module 600 is depicted in FIGS. 9 and 13. An exemplary network and system module 600 may include a CORBA server module 610, a trap generator module 620, a command line interface (CLI) server module 630 and a Web server module 640.

The Common Object request Broker Architecture (CORBA) server module 610 can provide a programmatic interface to the PSN 30. This interface enables the PSN 30 platform to be used in distributed CORBA applications. One such example is the SYSDESIS NetProvision distributed provisioning system 612. The CORBA server module 610 can contain the following management services that, in turn, support the corresponding client services which may be located in the platform services module 700 discussed below: Notification service; Diagnostic service; Configuration service; Provisioning service; Performance service; Accounting and billing service; Security service; and, Logging service. The CORBA server module 610 can contain interfaces to the following entities: the CORBA Object Request Broker (ORB), the CLI server module 630, the disk array 39, and indirectly with the notification service module 760 via the ORB. The CORBA server module 610 may send the alarms/events coming from the lower layers of the PSN system 30 to the platform services module 700.

The trap generator module 620 (sometimes referred to as an SNMP Master Agent), can provide an interface through which SNMP compliant network management stations 622 may communicate with the PSN 30 platform. The management station 622 may query the PSN 30 (via the trap generator module 620) for information through SNMP get requests, control and configure the PSN 30 through SNMP set requests, and receive asynchronous notifications through the SNMP trap mechanism.

The Web server module 640 can provide an administrative graphical user interface (GUI) which may be accessed from any standard web browser. The Web server module 640 is designed to be highly interactive and user-friendly.

The CLI server module 630 can provide a command driven user interface that may be accessed through a remote telnet session or a terminal connected directly to the PSN 30. The CLI server module 630 may be used primarily for administrative tasks and system debugging. The CLI server module 630 is scriptable thus enabling an end user to create automated system administration scripts.

Platform Service

In a preferred embodiment, the PSN 30 may further include a platform services module 700. However, in certain exemplary embodiments of the PSN 30 in accordance with the present disclosure, the platform services module 700 may not be present. Referring to FIG. 9, an exemplary platform services module 700 may include a system supervisor module 710, a name service module 720, a database service module 730, a call detail record (CDR) module 740, a logging service module 750, a notification service 760 and/or a process controller module 770. As shown in FIG. 9, the platform services module may interface with or be a sub-component of the PCS 200.

The system supervisor module 710 can be a collection of components and interfaces that provide failure detection, failure reporting, and failure recovery of events raised by the PCS 200 hardware and software components. The system supervisor module 710 may monitor local resources such as CPU utilization, disk space, and memory usage, and raises alerts based on configurable trigger conditions. The system supervisor module 710 may also react to these conditions and determine the control events to send to the appropriate components within the PCS 200 to attempt a remedy. The system supervisor module 710 may also coordinate with peer supervisor manager(s) running on separate hosts. The system supervisor module 710 can be fault tolerant and be able to recover from the following failure types: whole node failures, where an entire SBC fails; single process failures, where only a single service fails; and, communication failures, where either a communication link and/or a network interface fails.

The PSN system 30 can have many distinct services, such as the logging service (via logging service module 750) and the notification service (via notification service module 770), and system objects, such as truck lines and subscriber lines. The name service module 720 can abstract out the local details of these services/objects and provides a clean interface to them. The name service module 720 also may contain a fault tolerant dictionary of all registered services/objects. The name service module 720 can function as a resource locator for the PCS 200 software components. Additionally, distributed services may use the name service module 720 to register their location, which clients then can retrieve by invoking the name service modules 720's lookup interface.

Interfaces to a shared database server within the PSN 30 (e.g., disk array 39) can be provided via Open Database Connectivity (ODBC) and Java Database Connectivity (JDBC). The database services module 730 can provide for resource provisioning, subscriber profiles, service configuration, and platform configuration. These interfaces may isolate the disk array 39 (i.e., database) from the applications running on the system 30 as well as provide specialized data access for the specific requests made by the applications.

The database services module 730 may store the following illustrative types of information: Subscriber profiles; System configuration data; Resource provisioning data; Service-specific data; Fault-tolerant state; and Distributed/shared state. The storage and access requirements of these data types may vary. For example, the system configuration data may identify the location where different PSN 30 software elements are executed. The resource provisioning data may identify items such as route groups, trunk groups, and channel encoding methods. These data types are typically read at system initialization and refreshed only when necessitated by some administrative action. By contrast, call state and shared state data such as active subscriber records share the need to persist across process failures and are much shorter lived in duration. They have a requirement for low-latency access. The RDBMS of the database services module 730 ideally satisfies these differing requirements by efficiently using the system's in-memory storage ability along with disks and redundant memory to extend and maintain data durability. The database services module 730 may also provide interfaces for administrative access to perform such tasks as initial data provisioning, backing-up and restoring system data, updating the database schema to a new revision, and monitoring the health of the network. Both a command line interface (CLI) and a Web-based interface may be provided.

The call detail record (CDR) module 740 can collect the call records 284 produced by call agents. The service stores these records in data files on disk and transfers these files to a billing mediation system (BMS). The nature of the information the CDR module 740 provides allows it to be highly tolerant of CPU and process failures. The CDR module 740 can support administrative interfaces for “rolling over”from a current data file into a new data file on demand or via configuration parameters in the startup scripts. The CDR module 740 may also protect data from failures outside the control of the PSN system 30 by being able to store billing information for some period of time (e.g., three days) on a disk, thereby maintaining a short-term archive which is accessible long after a failure has been corrected.

The logging service module 750 can serve as a centralized logging coordinator for all clients running in the PSN 30 environment. The logging service module 750 may essentially functions as a collection agent for diagnostic, trace, and log events that are produced by various components of the PSN system 30. Once collected, the logging service module 750 may package the messages, and sends these messages to the appropriate persistent data store.

The notification service module 760 may provide for routing of an alarm/event generated by the PSN system 30 to all applications that subscribe to that specific alarm/event. The notification service module 760 may route these alarms/events to a network and system manager module 600 which, in turn, may route them to the external interfaces. These external interfaces can include a CORBA interface, third-party network management system (NMS), an operations support system (i.e., using SNMP traps), or a command line interface (CLI) interface. When a failure occurs, notification may occur at all levels. For example, a trunk failure sends an alarm signal to its local management processor (i.e., a communications resource module 8 or digital signal processing resource modules 90). That processor may then notify an access processing module 70 which in turn may light a local failure LED on the card's front panel and close a relay to signal unambiguously other equipment in the operating environment. The access processing module 70 may then notify a control processing module 40 so that remote management may be notified.

The process controller module 770 may handle control events sent by the system supervisor to start/stop processes.

Access Control Subsystem Software

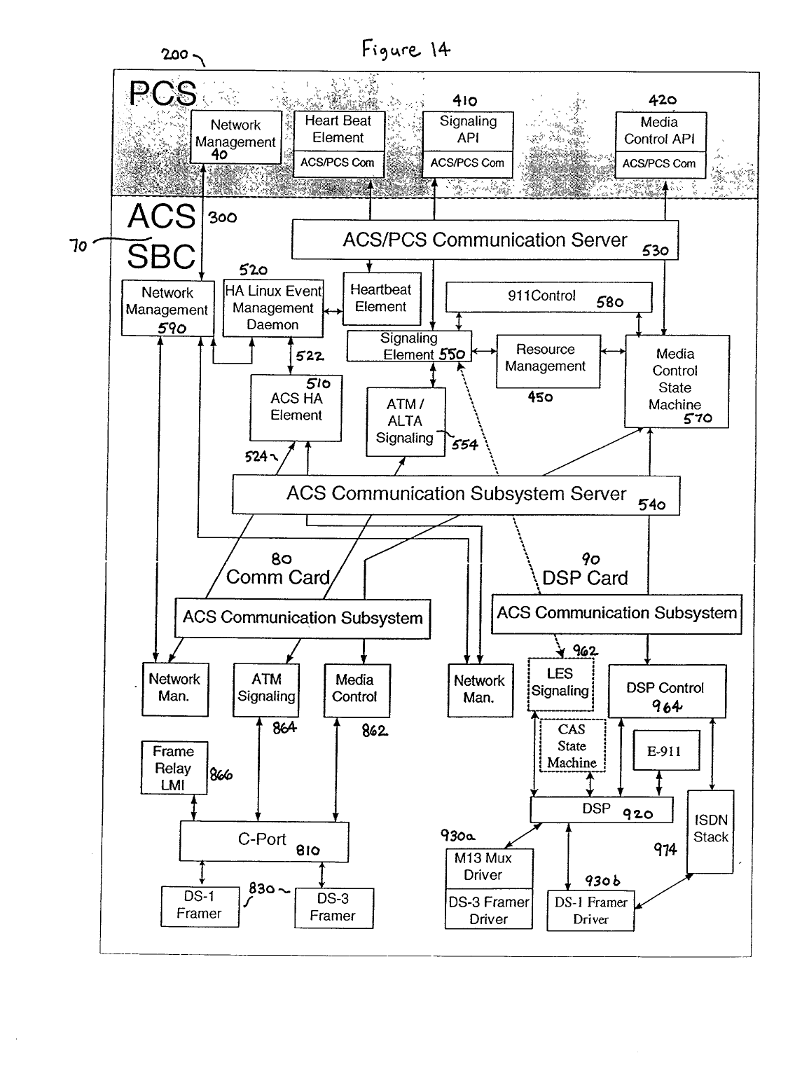

In an exemplary embodiment, the Access Control Subsystem (ACS) 300 may be is distributed across two layers of the architecture as shown in FIG. 14. The ACS 300 can communicate with the call control layer 280 above and the hardware below (e.g., access processing modules 70, communications resource modules 80 and digital signal processing resource modules 90). The three major functional responsibilities of the ACS 300 are signaling, media control and maintenance/management. In one embodiment, the core signaling and media functions reside on the (redundant) access processing modules 70. This approach may simply High Availability implementation, but does not preclude distribution and duplication of these functions for higher scalability

HA Linux Domain Component—Access processing module:

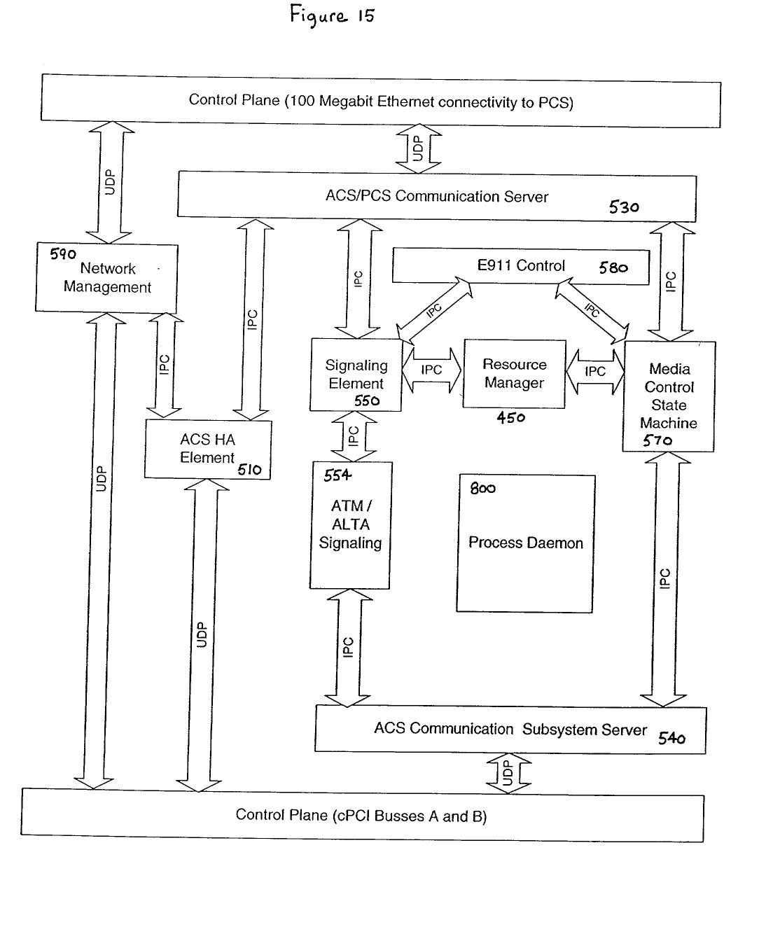

In one embodiment, the ATM, ALTA, and E911 protocol stacks are located on the HA Linux Domain Component as shown in FIG. 15. The architecture of the protocol stacks permits them to be distributed to appropriate I/O when using distributed stacks. Specific entities within this component are discussed below.

The ACS HA Element 510 may be responsible for interfacing with the HA Linux System Configuration/Event Manager (SCEM) 520 via a SCEM API 522 and with the Network Management 590 via an IPC mechanism 524. The HA Linux SCEM 520 is responsible for providing event notification of chassis events, fault detection, switching to redundant devices, and reintegrating replaced objects. The ACS HA Element 510 will be responsible for receiving chassis event notification messages, reformatting them for Network Management 590, and passing the event information to Network Management 590. Each access processing modules 70 will notify the HA Linux Event Manager 520 when it loses its connection to its peer access processing module 70 in the same ACS 300 chassis. If the connection was lost with the Backup access processing module 70, then an attempt is made to restart the Backup access processing module 70 via the SCEM 520. Otherwise the connection was lost to the Primary access processing module 70. The HA Linux Event Manager 520 can use the SCEM API 522 to switch the Primary access processing module 70 designation to itself, and then it will attempt to restart the other access processing module 70 using the SCEM API 522.

The ACS/PCS Communication Server 530 can provide a connection oriented reliable transport mechanism between the PCS 200 and ACS 300 processes using UDP on the control plane. The server 530 can inform ACS 300 client processes whenever a PCS 200 processes is either connecting to or disconnecting from them. The server 530 can also provide message multiplexing and de-multiplexing functionality for each connection.

The ACS Communication Subsystem Server 540 can provide a connection oriented reliable transport mechanism between the access processing module 70 processes and processes running on the CRMs 80 and DRMs 90 (I/O cards). This communications sub-system can utilize UDP on the ACS 200 control plane (i.e., cPCI busses). The ACS Communication Subsystem Server 540 preferably is functionally equivalent to the ACS/PCS Communications Server 530 except in the area of heartbeat message generation. The ACS Communication Subsystem Server 540 preferably is not responsible for generating heartbeat traffic to all the I/O cards in the ACS 300. The I/O card (CRMs 80 and DRMs9O) HA Linux cPCI drivers preferably provide this functionality.

The ATM/ALTA Signaling Element 550 can provide the ATM and ALTA Telephony signaling 544 processing for the system 30. The signaling element 550 is a port of the NetPlane ATM product to the HA Linux environment on the access processing module 70. The NetPlane product provides the following features: UNI 4.0; PNNI 1.0; ILMI 4.0; IPOA; and ALTA Signaling 2.0. ATM connection management functionality preferably is split among the Signaling Element 550, Resource Management 450, and the PCS call control layer 280.

The resource manager 450 can responsible for maintaining ACS 300 provisioning information, tracking the current state of all hardware elements within the ACS 300, assigning/designing hardware resources in response to call setup/teardown requests, and sharing critical data/state information with its backup peer via NetPlane Redundancy Management Software (RMS). The provisioning information preferably consists of: Statically assigning Circuit Identification Codes (CIC) to each DS-0 on the DRM 90 Cards; Mapping CIC's to Trunk Identifiers which correspond to physical IMT's; Mapping one or more Trunk Identifiers to a Trunk Group; Mapping ATM LES PVC's to ATM Trunk Identifiers, if AAL-2 LES is supported; Mapping ATM SVC destinations to a single ATM Trunk Identifier; DSP 920 Channel parameters (CODEC's, Echo Tail, etc.) for the pre-defined channel types supported by the media API; and the MIP's requirements for each predefined channel type. This hardware state information preferably consists of: the current active SVC/PVC's on all CRM 80 cards; the current active Frame Relay Connections on all CRM 80 Cards; the current active DS-Os on all DRM 90 Cards; the current available MIP's on all DSP 922's on each DRM 90 Card; the current active connections within the ACS 300 (ATM to ATM connections, ATM to PSTN connections, PSTN to PSTN connections, IVR to ATM connections, IVR to PSTN connections and 911 connections.

The Signaling Element 550 preferably is responsible for providing Connection Control for PVC's, providing the signaling control API 410 glue layer between the call agent and the ATM/ALTA signaling stacks, interfacing with the Resource Management 450, and updating its backup element via Redundancy Management Software (RMS) Element. Thus, the Signaling Element 550 can provide a glue layer between the signaling control API 410 and the ALTA API. Based on performance considerations, the Call control Signaling API 410 may be modified to be the ALTA API.

The Media Control State Machine 570 can provide the state machine for the Media Control API 420. The Media Control API 420 can support call setup/teardown functionality, call processing functionality, PSTN CLASS Feature support, IVR functionality, etc. The Media Control State Machine 570 may also maintain connections with the media control elements on the CRM 80 and DRM 90 I/O cards. These connections allow the Media Control State Machine 570 to send setup/teardown circuit connections commands to the CRM 80 and DRM 90 cards. Additionally, the Media Control State Machine 570 may update its backup element using the RMS element. The Media Control State Machine 570 supports the Media Control API 420.

Support for E911 connectivity to Public Service Access Points (PSAP's) is mandatory for CLEC certification. The E911 control 580 located here in combination with the E911 MF signaling on the DRM 90 Card provide this functionality.

The network management 590 may be responsible for providing provisioning, control, and statistics gathering functionality for elements in the ACS 300. The network management 590 can interface with the following access processing module 70 elements: ACS/PCS Communications Server 530; ACS Communications Subsystem Server 540; E911 Control 580; Signaling Element 550; Resource Management 450; Media Control State Machine 570; ACS HA Element 510; ATM/ALTA Signaling Stack 554; HA Linux cPCI CRM 80 Card Driver 840; HA Linux cPCI DRM 90 Card Driver 940; Interface with Network Management Element on CRM 80 Card; Interface with Network Management Element on DRM 90 Card and Interface with Network Management Element on PCS 200 control process module 40.

The Process Daemon 800 may be responsible for starting, stopping, restarting, and monitoring the health of all the ACS 300processes, with the exception of Network Management 590 on the access processing module 70. There is a process daemon for each of the I/O cards as well serving the same function.

CRM Component

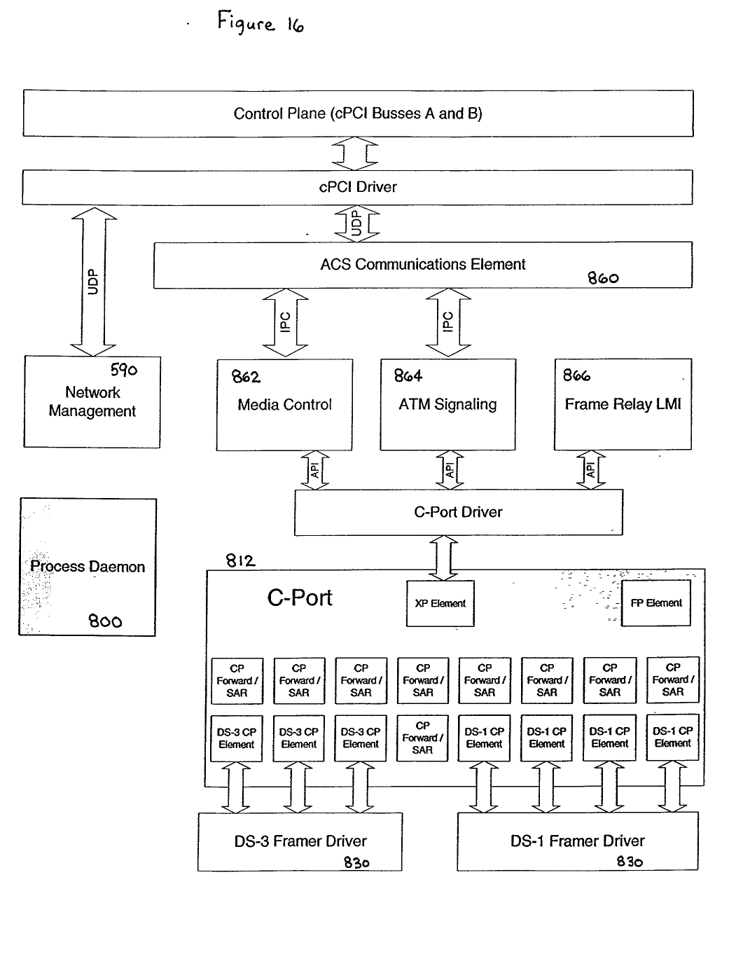

The CRM 80 can perform the bulk of the processing-intensive, real time traffic processing (with the exception of the Voice Processing requirements that are handled on the DRM 90 Card). See FIG. 16. The ACS Communication Element 860 can provide a connection oriented reliable transport mechanism between the CRM 80 processes and the access processing module 70 processes. This communications sub-system may utilize UDP on the ACS control plane (cPCI busses). The ACS Communication Subsystem Server 540 preferably is functionally equivalent to the ACS/PCS Communications Server 530 except in the area of heartbeat message generation. The ACS Communication Subsystem Server 540 preferably is not responsible for generating heartbeat traffic to all the CRM 80 and DRM 90 cards in the ACS 300. The CRM 80 and DRM 90 (I/O cards) HA Linux cPCI drivers (840 and 940, respectively) preferably provide this functionality.

The Media Control Element 862 may be responsible for sending call setup/teardown commands as well as forwarding table update commands to the executive processor on the C-Port Network Processor 812. The Media Control State Machine 570, on the access processing module 70, can send these commands over the cPCI backplane utilizing the ACS Communications Element 860 on the CRM 80. The commands are then passed to the XP processor within the C-Port network processor 812 via the C-Port Driver.

The C-Port Communications Processors (CP's) groom ATM Signaling and OA&M traffic cells from the ATM connections. These control cells are SAR'ed by other CP resources and are then sent to the ATM Signaling element 864 via the C-Port Driver. The ATM Signaling Element 864 may be responsible for sending and receiving ATM Signaling and OA&M primitives between the CRM 80 and the ATM/ALTA Signaling Element 550 on the access processing module 70. Signaling and OA&M Primitives that were sent to the CRM 80 from the access processing module 70 are preferably sent to the XP from the ATM Signaling Element 864 via the C-Port driver. The XP then forwards the primitives to a CP resource for SAR'ing and then to the appropriate CP for transmission into the ATM network.

The Frame Relay LMI 866 may be responsible for Group of Four and ANSI functionality for the Frame Relay connections on the CRM 80. The C-Port Communications Processors (CP's) will groom Frame Relay LMI traffic and Frame Relay element via the C-Port Driver. The Frame Relay LMI 866 processes incoming LMI requests and generates periodic LMI traffic. Outgoing traffic is sent to the XP via the C-Port driver. The XP then forwards the traffic to a CP resource to build a frame and then to transmit the LMI message. This code consists of a port of the LMI element in the NetPlane Frame Relay stack.

DRM 90 Component

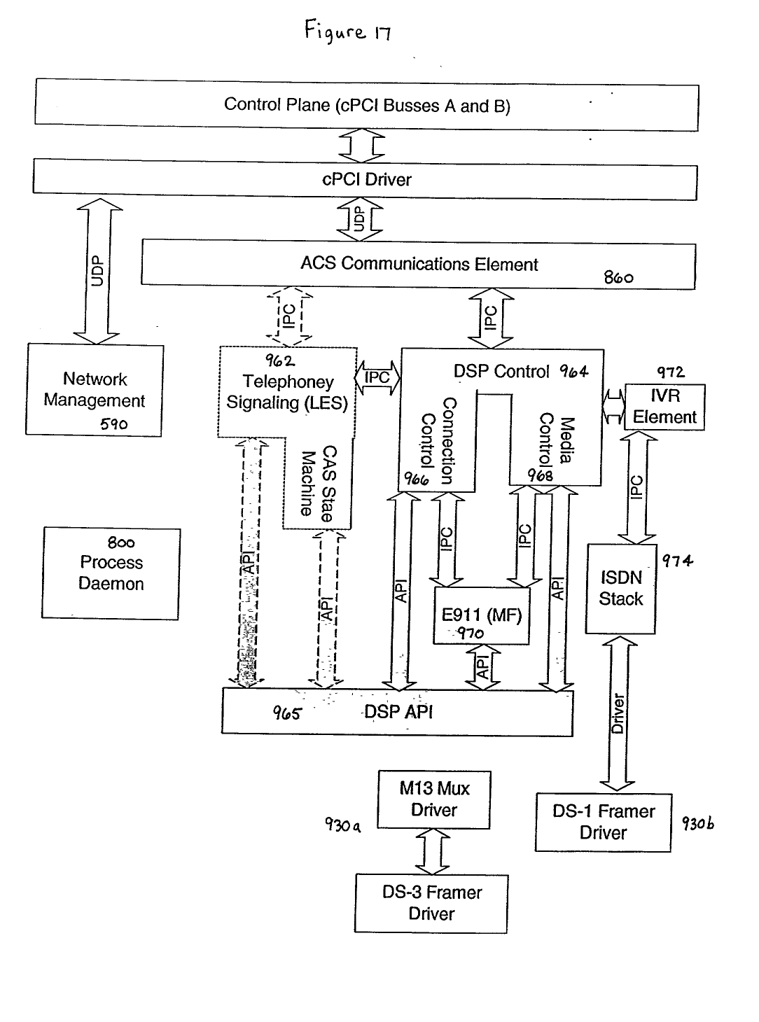

The DRM 90 software provides functions to connect the circuit-switched and packet/cell-switched networks. Additionally, it provides for attachment to services such as E911 and CCS-controlled (i.e. ISDN) services, as shown in FIG. 17.

The ACS Communication Element 860 can provide a connection oriented reliable transport mechanism between the DRM 90 processes and access processing module 70 processes. This communications sub-system utilizes UDP on the ACS control plane (cPCI busses). The ACS Communication Subsystem Server 540 preferably is functionally equivalent to the ACS/PCS Communications Server 530 except in the area of heartbeat message generation. The ACS Communication Server 530 preferably is not responsible for generating heartbeat traffic to all the CRM 80 and DRM 90 cards in the ACS 300. The CRM 80 and DRM 90 HA Linux cPCI drivers preferably provide this functionality.

An LES Telephony Signaling Element 962 may appear as shown in FIG. 17. The feature is implemented in compliance with ATM Forum af-vmoa-0145.000, preferably with the limitation that one AAL2 PDU per cell would be supported.

The DSP Control Element 964 may be responsible for interfacing with the DSP 922's. This interface can consist of a DSP API 965 via the DSP 922 Device Driver. The DSP Control Element 964 can be responsible for converting Media Control API 420 requests into the equivalent DSPAPI 965 requests. The DSP Control Element 964 preferably incorporates two state machines (DSP connection control 966 and DSP media control 968), one to handle connection control requests and one to handle media control requests. The DSP connection control 966 and DSP media control 968 state machines are responsible for interfacing to the DSP API 965, as well as the E911 Element 970, and the IVR Element 972.

Connection control requests are related to call setup and teardown, as well as supporting certain CLASS Features such as call waiting. These requests instruct the DSM 90 to allocate resources, set up mapping to a VPI/VCI tag for a connection, connecting a DSP resource to another resource etc. Media control requests are related to selecting a particular CODEC, setting Echo Tail length, and IVR requests such as playing a tone or message, etc. Requests such as CODEC selection are sent to the DSP 922, while IVR requests are sent to the IVR element 972.

Preferably, the DRM 90 provides some level of IVR functionality. In one embodiment, an external IVR unit is used. The internal IVR element 972 preferably provides: Tone Generation; Playing Messages; and Digit Capture. The IVR element 972 receives IVR specific requests from the DSP Control Element 964 (Media Control State Machine). The IVR element 972 may then leverage DSP functionality via the DSP Control element 964 and utilizes the ISDN Stack 974 to access external IVR boxes. The ISDN stack 974 may be provided to function with third party legacy Central Office (CO) equipment using the ISDN PRI D channel as its control plane (e.g., Cognitronics).

The E911 block 970 provides support for emergency services functions. At the physical layer this is an “Enhanced MF” trunk signaling protocol using CAS for the “wink”and MF tones to convey addressing. E911 970 preferably is redundant on separate cards. The E911 stack 970 passes up messages to high layers responsible for synchronizing the instances of this stack on the separate cards. The protocol may make direct calls to the DSP API 965 (for the generation and detection of MF tones). Events are filtered through DSP Media Control 968 and DSP Connection Control 966 and relayed to E911 Control 580 on the access processing module 70.

The Network Management 590 may interface with the following DSM 90 elements: ACS Communications Element 860; Telephony Signaling 962, if LES is implemented; DSP Control 964; IVR Element 972; E911 970; ISDN Stack 974; M13 Mux Driver 932; DS-1 Framer Driver 930b ; DS-3 Framer Driver 934; and interface with Network Management 590 on access processing module 70. The Network Management 590 uses SNMP over UDP when communicating with the Network Management elements on the access processing module 70. This UDP traffic is transported over the cPCI bus.

Operating Systems

Different operating systems (OS) may be used across the PSN 30 platform. All communication between OS's can be made OS-independent by using IP across either the PCI bus (in cPCI segments A and B) or 100 Mb Ethernet (between Solaris and HA Linux domains). In one embodiment, HA Linux is used for the cPCI A and cPCI B segments. OSE may be used for the access processing modules 70.

Preferably, the access processing modules 70 uses HA Linux 1.2 or above, the DRMs 90 and CRMs 80 use OSE, and the control processing modules 40 use Solaris CD 4.0RR or above.

Additional Considerations

High Availability (HA) Features

The PSN 30 architecture supports High Availability (HA). Preferably, with High Availability, calls-in-progress will not be dropped, all “database”information will be preserved in the event of a failure, and the state of the system is always externally visible. At the physical layer there preferably is full redundancy within the architecture. However, for “ATM-side”bearer traffic, the network provider preferably is used to reroute traffic. For the PSTN side 1:1 redundancy is available if the operator requires it. The operating systems and protocol stacks each have HA support. The complete HA architecture is a combination of different HA components from the OS's and protocol stacks.

There are four components for HA: a high MTTF, redundancy, failure notification (alarms), and hot swap. Each hardware function in the system 30 preferably has at least one backup to avoid “single point of failure”at the component level. Redundancy at the shelf level is the option of the operator. In order for the redundant PSN 30 modules to be put into service, some method of automatic switchover is preferred. For modules connected to “external”network interfaces this is usually referred to as Automatic Protection Switching (APS). Automatic switch over between “internal”interfaces uses software mechanisms described below. The system preferably supports 1:1 redundancy with APS on the PSTN network interfaces. An external “Y”cable is used to connect the external network to the two cards in the 1:1 pair. In the event of a protection switch over the current card stops driving its leg of the Y and the new card starts driving its leg. The ATM interfaces rely on traffic being rerouted externally to the box.

At address the failure notification function, when a failure occurs with the PSN 30, the operator should be notified. This notification preferably occurs at all levels. For example, a trunk failure will send an alarm signal to its local management processor. That processor will notify the HA Linux environment which will in turn light a local failure LED and close a relay to signal other equipment in the operating environment through an unambiguous signal. The HA Linux environment will also notify the system management function in the Solaris domain so that remote management can be notified.

In the case of Hot Swap, when either a) a new module is being inserted into the system 30 to increase capacity or b) a failed module is being replaced to restore capacity, the system 30 should continue to operate normally during the insertion/removal process. Every module in the system 30 is designed to be inserted or removed without affecting normal system operation.

In regards to operating system(s), in a preferred embodiment, there are three operating systems running in various sections of the system. Each supports certain HA features natively and there is some overlap in the features each provides. The HA features of OSE in a preferred embodiment provide the increased reliability of a true virtual memory subsystem and the ability to run backup processes concurrently with the active processes. This latter feature also permits on-board application/OS replacement without interference with ongoing operation. Additionally, the bulk of the required application-independent HA features for the Platform Control Subsystem (PCS) 200 preferably are tied to the HA Linux running on the access processing module 70. Lastly, Sun SPARC Solaris is currently evolving toward a full HA support. The control processing modules 40 can function independently of the other(s) and either may be removed without affecting the other at the hardware level. HA support above this level is implemented by specific applications.

OS Boundary:

Since HA is a system-wide feature, the OS's should act cooperatively. This cooperation is based upon a common method of communication between the different OS's —UDP datagrams with an added reliable delivery feature. The separate domains communicate “health”across the OS boundaries using this reliable UDP transport. Any module failing to respond appropriately to the health exchange preferably is deemed to be “unavailable”. This UDP transport is physical-layer-independent from the perspective of the OS.

Application:

Since there are multiple OS's running in the system it is not possible to rely upon the HA features of a given OS system-wide. The communication stacks each have their HA component and that component is OS-independent. The applications use this software-redundancy so that backup software components are sufficiently synchronized with the current active software image to take over should the current software image (or its underlying supporting hardware) fail.

External Networks:

Preferably, the system 30 leverages those features available as part of the network topology. PNNI rerouting and Soft Permanent Virtual Circuits (SPVC's) are examples of network features that contribute to overall HA within the complete operating environment.

I/O Configurations:

The I/O slots may be populated by CDMs 80 and DRMs 90 as need to so as best to satisfy the servicing demands being placed on a PSN 30. Additionally, the PSN 30 system, as disclosed herein, may be combined (i.e., interlinked) with other similar PSNs 30 so as to be able provide greater servicing capabilities. For example, three PSN 30s as described herein could be combined together in this way.

While the systems and methods ddescribed herein have been disclosed in connection with the preferred embodiments shown and described in detail, various modifications and alternate embodiments thereon will become readily apparent to those skilled in the art. Accordingly, the spirit and scope of the present invention is to be determined by the following claims.

What is claimed is:

1. A programmable network services node system for providing call services to subscribers, said system comprising:
at least one control processing module which provides platform processing control of said system and wherein said at least one control processing module can process received services programming instructions;
at least one communications resource module which performs call processing, said at least one communications resource module comprising at least one network interface, wherein said at least one network interface interfaces with at least one of the following types of network: a packet-based network and a cell-based network;
at least one digital signal processing resource module which performs call protocol conversions, said at least digital signal processing resource module comprising at least one circuit interface which interfaces with a circuit-based network;
at least one switching resource module for providing switching controls within said system, wherein said at least one switching resource module is coupled to at least one of said at least one control processing module and wherein said at least one communications resource module and said at least one digital signal processing resource module are coupled to at least one of said at least one switching resource module; and
at least one access processing module for providing access processing control within said system, wherein said at least one access processing module is coupled to at least one of said at least one switching resource module.

2. The system of claim 1, further comprising a meshed network, wherein said at least one communications resource module and said at least one digital signal processing resource module populate said meshed network.

3. The system of claim 2, wherein said meshed network is further populated by said at least one switching resource module.

4. The system of claim 2, wherein said meshed network comprises communication channels having digital data transmission rates of up to approximately 1 Gb/s.

5. The system of claim 2, wherein said at least one communications resource module further comprises a network processor module, a control processor module and a mesh interface wherein said mesh interface interfaces with said meshed network.

6. The system of claim 5, wherein said at least one network interface of said of at least one communications resource module resides on a mezzanine card having a plurality of DS-3 interfaces and DS-1 interface.

7. The system of claim 5, wherein said mesh interface comprises a plurality of serial drivers and a field programmable gate array.

8. The system of claim 2, wherein said at least one digital signal processing resource module further comprises a control processor module, a digital signal processor module and a mesh interface which interfaces with said meshed network.

9. The system of claim 8, wherein said at least one circuit interface of said at least one digital signal processing resource module includes a DS-3 interface and a DS-1 interface.

10. The system of claim 8, wherein said digital signal processor module comprises an array of digital signal processors.

11. The system of claim 8, wherein said mesh interface comprises a plurality of serial drivers and a field programmable gate array.

12. The system of claim 1, further comprising at least one status module, wherein said at least one status module provides a connection between said at least one control processing module and said at least one switching resource module.

13. The system of claim 12, wherein said at least one status module includes an Ethernet switch.

14. The system of claim 12, wherein said at least one status module provides a connection between said at least one switching resource module and at least one of the following: said at least one access processing module, said at least one communications resource module and said at least one digital signal processing resource module.

15. The system of claim 1, wherein said system comprises:
first and second switching resource modules; and
first and second access processing modules, wherein said first switching resource module is coupled to said second switching resource module, said first access processing module and said second access processing module, wherein said second switching resource module is coupled to said first access processing module and said second access processing module, and wherein said first access processing module is coupled to said second access processing module.

16. The system of claim 1, wherein said system comprises:
first and second switching resource modules; and
first and second control processing modules, wherein said first switching resource module is coupled to said second switching resource module, said first control processing module and said second control processing module, wherein said second switching resource module is coupled to said first control processing module and said second control processing module, and wherein said first control processing module is coupled to said second control processing module.

17. The system of claim 1, further comprising at least one signaling system 7 interface, wherein said at least one signaling system 7 interface is coupled to at least one of said at one control processing module.

18. The system of claim 17, wherein said system comprises:
first and second control processing modules; and
first and second signaling system 7 interfaces, wherein said first control processing module is coupled to said second control processing module, said first signaling system 7 interface and said second signaling system 7 interface, wherein said second control processing modules is coupled to said first signaling system 7 interface and said second signaling system 7 interface, and wherein said first signaling system 7 interface is coupled to said second signaling system 7 interface.

19. The system of claim 1, further comprising a chassis having a plurality of CompactPCI-compliant card locations and wherein said at least one control processing module comprises a scalable processor architecture-based CompactPCI form factor single board computer, said at least one switching resource module comprises an IP switch board CompactPCI form factor single board computer, said at least one access processing module comprises a microprocessor CompactPCI form factor single board computer, said at least one communications resource module comprises an input/output CompactCPI card and said at least one digital signal processing resource module comprises an input/output CompactCPI card.

20. The system of claim 1, wherein said at least one switching resource module comprises a plurality of Ethernet channel interfaces.

21. The system of claim 1, further comprising a data storage module for storing system configuration data and subscriber information data, wherein said data storage module is coupled to said at least one control processing module.

22. The system of claim 1, further comprising a network and system management module coupled to said at least one control processing module.

23. The system of claim 1, further comprising a platform services module coupled to said at least one control processing module.

24. The system of claim 1, wherein said programmable network node system functions as at least one of the following: a media gateway integrator, an edge switch router, a media gateway controller, a signaling gateway, a call agent and an enhanced application server.

25. A computer-readable storage medium containing computer executable code for operating a programmable network services node system, said computer-readable storage medium comprising:
a platform control subsystem comprising a service application layer for facilitating call processing services, a call control layer for providing basic originating and terminating call models and an object-based execution environment for processing calls, and a call control interface for bridging said service application layer and said call control layer; and
an access control subsystem for managing the identification and establishment of call endpoints and call channels within said system and a switch router layer for routing call.

26. The computer-readable storage medium of claim 25, wherein said service application layer comprises an application server for hosting a service logic execution environment, wherein said service logic execution environment provides support for enhanced call processing services, said application server comprising a servlet server and an Enterprise JavaBeans server.

27. The computer-readable storage medium of claim 26, wherein said service logic execution environment is an open environment isolated from said call control layer.

28. The computer-readable storage medium of claim 27, wherein said service logic execution environment is a JAIN-based execution environment.

29. The computer-readable storage medium of claim 26, wherein said service logic execution environment supports third-party service logic programs.

30. The computer-readable storage medium of claim 25, wherein said call control interface is a Java call control interface.

31. The computer-readable storage medium of claim 25, wherein said platform subassembly further comprises at least one of the following management interfaces: a command line interface, a web-browser interface for subscriber self-provisioning, a service and element management module having a common object request broker architecture agent, a simple network management protocol interface, and a common object request broker architecture agent application program interface.

32. The computer-readable storage medium of claim 25, wherein said platform subassembly further comprises at least one of the following platform services modules: a process supervision and fault management module, a name service module, a database service module, a call detail records module, a logging service module and a process controller module.

33. The computer-readable storage medium of claim 25, further comprising a signaling services application program interface and a media service application program interface, wherein said signaling application program interface and said media application program interface act as an interface between said call control layer and said access control subsystem.

34. The computer-readable storage medium of claim 25, wherein said call control layer comprises a call control infrastructure module to implement call services, a call table module to manage active calls, signal control module to process call signal control information and a media control module to isolate said call control layer from the implementation of said media services application program interface.

35. A programmable network services node system for providing call services to subscribers, said system comprising:
platform processing means for providing platform processing control of said system and wherein said platform processing means includes for processing received services programming instructions;
call processing means for performing call processing, said call processing means comprising a network interface means for interfacing with at least one of the following types of network: a packet-based network and a cell-based network;
a call protocol conversion means for converting call protocols, said call protocol conversion means comprises a circuit interface means for interfacing with a circuit-based network;
a switch control means for providing switching controls within said system; and
an access processing means for providing access processing control within said system, wherein said switch control means is coupled to said switch control means.
